(19) United States
(12) Patent Application Publication
(10) Pub. No.: US 2026/0290814 A1
(43) Pub. Date: Sep. 24, 2026

(54) NICKEL-BASED ACTIVE MATERIAL PRECURSOR FOR LITHIUM SECONDARY BATTERY, PREPARING METHOD THEREOF, NICKEL-BASED ACTIVE MATERIAL FOR LITHIUM SECONDARY BATTERY FORMED THEREOF, AND LITHIUM SECONDARY BATTERY COMPRISING POSITIVE ELECTRODE INCLUDING THE NICKEL-BASED ACTIVE MATERIAL

(71) Applicant: SAMSUNG SDI CO., LTD., Yongin-si (KR)

(72) Inventor: Doyu KIM, Yongin-si (KR)

(21) Appl. No.: 19/689,852

(22) Filed: May 27, 2026

Related U.S. Application Data
(63) Continuation of application No. 17/170,364, filed on Feb. 8, 2021.

(30) Foreign Application Priority Data
Oct. 29, 2020 (KR) 10-2020-0142522

(51) Int. Cl. H01M 4/525; C01G 53/50; H01M 4/02; H01M 4/131; H01M 4/134; H01M 4/1391; H01M 4/1395; H01M 4/36; H01M 4/505; H01M 4/58; H01M 10/0525

(52) U.S. Cl. CPC H01M 4/525; C01G 53/50; H01M 4/131; H01M 4/134; H01M 4/1391; H01M 4/1395; H01M 4/364; H01M 4/505; H01M 4/58; H01M 10/0525; C01P 2002/74; H01M 2004/028

(57) ABSTRACT

A nickel (Ni)-based active material precursor for a lithium secondary battery, a preparing method thereof, a Ni-based active material obtained therefrom, and a lithium secondary battery including a positive electrode including the same, are provided. The Ni-based active material precursor includes a secondary particle including a plurality of particulate structures, wherein each of the particulate structures includes a porous core portion; and a shell portion including primary particles radially arranged on the porous core portion. Phosphorus (P) may be present in the porous core portion, between the plurality of primary particles, and on the surface of the secondary particle, and the content of the phosphorus may be in a range of 0.01 wt % to 2 wt % based on a total weight of the Ni-based active material precursor.

### CROSS-REFERENCE TO RELATED APPLICATION

This application is a continuation of U.S. patent application Ser. No. 17/170,364, filed on Feb. 8, 2021, which claims priority to and the benefit of Korean Patent Application No. 10-2020-0142522, filed on Oct. 29, 2020, in the Korean Intellectual Property Office, the entire content of which is incorporated herein by reference.

### BACKGROUND

### 1. Field

One or more aspects of embodiments of the present disclosure relate to a nickel (Ni)-based active material precursor for a lithium secondary battery, a preparing (preparation) method thereof, a Ni-based active material for a lithium secondary battery formed thereof, and a lithium secondary battery including a positive electrode including the nickel-based active material.

### 2. Description of Related Art

With the development of portable electronic devices, communication devices, and/or the like, there is a great need for the development of lithium secondary batteries having high energy density. However, a lithium secondary battery having high energy density may have poor safety, and thus there is a need to improve safety. As a positive active material of lithium secondary batteries, a lithium-nickel-manganese-cobalt composite oxide, a lithium-cobalt oxide, and/or the like has been used. However, when such a positive active material is used, the travel distance of lithium ions during charging and discharging is determined by the size (e.g., diameter) of secondary particles, and the charging and discharging efficiency of such materials may be insufficient (e.g., not high enough) due to such physical distance. Furthermore, the lithium secondary battery may have a decreased lifespan, an increased resistance, and/or unsatisfactory capacity characteristics due to cracks occurring in the primary particles after repeated charging and discharging of the lithium secondary battery. Therefore, improvement in these characteristics is desired.

### SUMMARY

One or more aspects of embodiments of the present disclosure are directed toward a novel nickel (Ni)-based active material precursor for a lithium secondary battery.

One or more aspects of embodiments of the present disclosure are directed toward a method of preparing the Ni-based active material precursor.

One or more aspects of embodiments of the present disclosure are directed toward a lithium secondary battery having improved lifespan characteristics by including a Ni-based active material obtained from the Ni-based active material precursor, and a positive electrode including the same.

Additional aspects will be set forth in part in the description that follows and, in part, will be apparent from the description, or may be learned by practice of the presented embodiments of the disclosure.

One or more embodiments of the present disclosure provide a nickel (Ni)-based active material precursor for a lithium secondary battery including a secondary particle including a plurality of particulate structures, wherein each of the plurality of particulate structures includes a porous core portion and a shell portion including primary particles radially arranged on the porous core portion; phosphorus (P) is present in the porous core portion, between the plurality of primary particles, and on the surface of the secondary particle; and the content of the phosphorus is in a range of 0.01 wt % to 2 wt % based on a total weight of the Ni-based active material precursor.

One or more embodiments of the present disclosure provide a method of preparing the nickel (Ni)-based active material precursor includes: a first act of supplying a feedstock at a first feed rate and stirring the feedstock to form a precursor seed; a second act of supplying the feedstock to the precursor seed formed in the first act at a second feed rate and stirring the feedstock to grow the precursor seed; a third act of supplying the feedstock to the precursor seed grown in the second act at a third feed rate and stirring the feedstock to adjust the growth of the precursor seed; and acts of washing a product obtained in the third act to obtain a preliminary Ni-based active material precursor, and supplying an ionizable phosphorus compound to the preliminary Ni-based active material precursor to obtaining a phosphorus-containing Ni-based active material precursor, wherein the feedstock includes a complexing agent, a pH adjusting agent, and a metal raw material for forming the nickel-based active material precursor, and the second feed rate of the metal raw material for forming the nickel-based active material precursor is greater than the first feed rate, and the third feed rate is greater than the second feed rate.

One or more embodiments of the present disclosure provide a nickel (Ni)-based active material for a lithium secondary battery including a secondary particle including a plurality of particulate structures, wherein each of the plurality of particulate structures includes: a porous core portion; and a shell portion including primary particles radially arranged on the porous core portion, and where lithium phosphate is present in the porous core portion, between the plurality of primary particles, and on the surface of the secondary particle.

One or more embodiments of the present disclosure provide a lithium secondary battery including a positive electrode including the Ni-based active material for a lithium secondary battery.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are schematic diagrams depicting a cross-sectional structure of a Ni-based active material precursor according to an embodiment; FIG. 1A showing a state before coating phosphorus (e.g., a phosphorus-containing compound) and FIG. 1B showing a state after coating phosphorus;

FIG. 2A is a schematic diagram of a secondary particle included in a Ni-based active material precursor according to an embodiment;

FIG. 2B is a schematic partial see-through perspective view of a particulate structure included in the secondary particle of FIG. 2A;

FIG. 2C is a detailed partial see-through perspective view of the particulate structure included in the secondary particle of FIG. 2A;

FIG. 2D is a schematic cross-sectional view of the surface of a secondary particle included in a Ni-based active material precursor according to an embodiment;

FIGS. 2E and 2F are SEM images of a cross-section of a Ni-based active material precursor prepared in Preparation Example 1 before and after phosphorus coating, respectively;

FIG. 3A shows time-of-flight secondary ion mass spectrometry (TOF-SIMS) analysis results of the surface of a Ni-based active material of Example 1;

FIG. 3B shows TOF-SIMS analysis results of the surface of a Ni-based active material of Comparative Example 1;

FIG. 3C is a graph comparing the normalized PO₃ intensities from the TOF-SIMS spectra of the Ni-based active materials of Example 1 and Comparative Example 1;

FIG. 3D is a graph comparing the normalized PO₃ intensities at a cross-section (inner portion), and at a shell portion (outer portion) and the surface (outer portion) of a secondary particle of a Ni-based active material of Example 1;

FIGS. 4A-4D show chemical mapping results of TOF-SIMS analysis for various elements, performed on cross-sections of the Ni-based active material of Example 1;

FIGS. 5A and 5B shows scanning electron microscope-energy dispersive X-ray Spectroscopy (SEM-EDX) analysis results of the Ni-based active material precursor of Preparation Example 1;

FIG. 6 shows lifespan characteristics (e.g., capacity retention rate) of the coin cells of Manufacture Example 1 and Comparative Manufacture Example 1;

FIG. 7 shows a graph quantifying volumes of gas generated in lithium secondary batteries prepared in Manufacture Example 1 and Comparative Manufacture Example 1 measured after charging and discharging at high temperature; and

FIG. 8 is a schematic view of a lithium secondary battery according to an embodiment.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described below, by referring to the drawings, to explain aspects of the present description. As used herein, the term “and/or” includes any and all combinations of one or more of the associated listed items. Expressions such as “at least one of,” “one of,” and “selected from,” when preceding a list of elements, modify the entire list of elements and do not modify the individual elements of the list.

It will be further understood that the terms “includes,” “including,” “comprises,” and/or “comprising,” when used in this specification, specify the presence of stated features, acts, steps, operations, elements, and/or components, but do not preclude the presence or addition of one or more other features, acts, steps, operations, elements, components, and/or groups thereof. Further, the use of “may” when describing embodiments of the present disclosure refers to “one or more embodiments of the present disclosure”.

Hereinafter, a nickel (Ni)-based active material precursor for a lithium secondary battery, a preparing (e.g. preparation) method thereof, a Ni-based active material obtained therefrom, and a lithium secondary battery including a positive electrode including the same will be described in more detail. Accordingly, it should be apparent to those skilled in the art that the following description of various embodiments of the present disclosure is provided for illustration purposes only, and not for the purpose of limiting the present disclosure as defined by the appended claims and their equivalents.

In the drawings, elements may be enlarged or exaggerated for clarity. The aforementioned descriptions are only for illustrative purposes, and it will be apparent that those skilled in the art can make various modifications thereto. In addition, in layered structures described below, when a layer is referred to as being “on” another layer, it can be directly on the other element or intervening elements may be present therebetween. When an element is referred to as being “directly on,” another element, there are no intervening elements present.

Provided is a nickel (Ni)-based active material precursor for a lithium secondary battery including a secondary particle including a plurality of particulate structures, wherein each of the plurality of particulate structures includes a porous core portion and a shell portion including primary particles radially arranged on the porous core portion; and phosphorus (P) is present in the porous core portion, between the plurality of primary particles, and on the surface of the secondary particle, wherein the content of phosphorus is in a range of 0.01 wt % to 2 wt % based on a total weight of the Ni-based active material precursor. In this regard, the surface of the secondary particle includes surfaces of the plurality of primary particles.

When the content of phosphorus is less than 0.01 wt % based on the total weight of the Ni-based active material precursor, improvement of electrochemical characteristics may be insignificant. When the content of phosphorus is greater than 2 wt %, the charge/discharge capacity of the material may considerably decrease.

As used herein, the term “phosphorus (P)” is interpreted to indicate phosphorus itself, or to include PO₃²⁻, PO₄³⁻, or any combination thereof.

As used herein, the terms “between the plurality of primary particles” and “between the plurality of primary particles of the shell portion” may include and/or refer to grain boundaries of the plurality of primary particles.

As used herein, the term “particulate structure” refers to a structure formed by the aggregation of a plurality of primary particles.

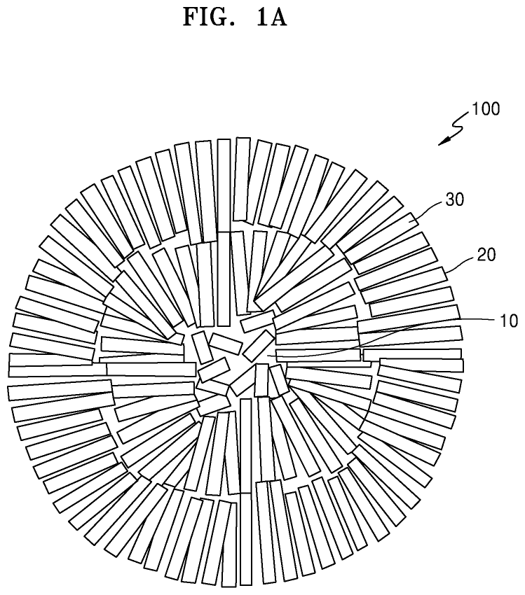

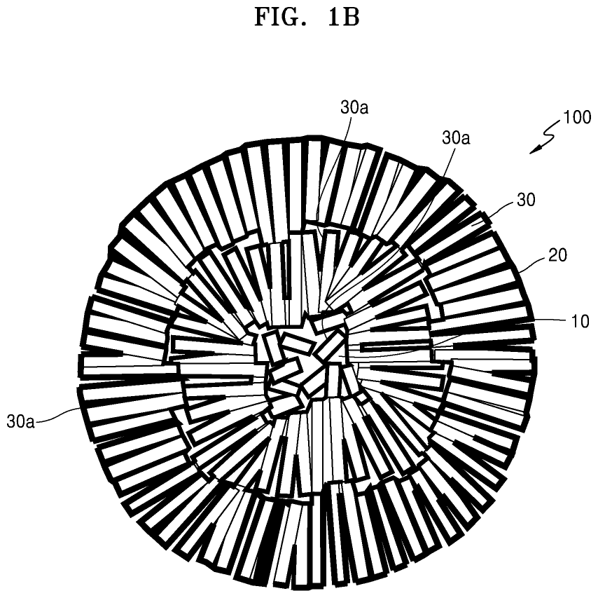

As used herein, the term “radially arranged” refers to a shape, arrangement, or orientation in which the major axes of primary particles included in the shell portion are arranged in a normal direction (e.g., perpendicular) to the surface of the particulate structure, or in (along) a direction inclined from the normal direction by an angle of ±30° or less, for example as shown in FIGS. 1B and 1C.

Forming a coating film utilizing lithium phosphate has been attempted to improve lifespan characteristics of a Ni-based active material.

However, in related art methods of forming a coating film, the coating film is formed only on the surface (e.g., outermost surface or shell) of the secondary particle of the Ni-based active material, and thus lifespan characteristics are not satisfactorily improved, or a deposition device may be required, thereby increasing manufacturing costs and/or limiting mass production.

However, embodiments of the present disclosure provide a Ni-based active material precursor that is mass-produced with reduced manufacturing costs and substantially uniform coating of phosphorus on the surfaces of and between a plurality of primary particles included in the Ni-based active material, as well as a Ni-based active material obtained therefrom. The Ni-based active material is a product obtained from the above-described Ni-based active material precursor, for example by mixing the Ni-based active material precursor and a lithium precursor, and heat-treating the mixture. The Ni-based active material is coated with lithium phosphate instead of phosphorus when compared with the Ni-based active material precursor.

The Ni-based active material precursor according to the present disclosure has a porous structure, in which primary particles are radially arranged for easy intercalation and deintercalation of lithium. The Ni-based active material precursor includes the porous core portion having pores and the shell portion having a radial arrangement structure. When an ionizable phosphorus compound is provided thereto, phosphorus may be well coated in the porous core portion and between the plurality of primary particles (e.g., at, in, and/or along one or more grain boundaries of the plurality of primary particles) of the shell portion of the Ni-based active material precursor. Also, phosphorus may be present on the secondary particle of the Ni-based active material in the form of a coating film. In this regard, the coating film may be a substantially continuous or discontinuous coating film.

In preparation of the Ni-based active material precursor including phosphorus, an act (process) of providing an ionizable phosphorus compound to a preliminary Ni-based active material precursor is performed. This process may be performed by a wet process using the preliminary Ni-based active material precursor and the ionizable phosphorus compound. This process provides a mixture (e.g., solution, partial solution, or suspension) of the ionizable phosphorus compound and (e.g., in) a solvent to the preliminary Ni-based active material precursor. The preliminary Ni-based active material precursor is impregnated with the mixture of the ionizable phosphorus compound and the solvent and then dried. Through this process using the mixture of the ionizable phosphorus compound and the solvent, phosphorus (P) may be adsorbed on (and/or in some embodiments absorbed in) the porous core portion, the shell portion, and/or the surface of the secondary particle of the precursor, thereby providing the Ni-based active material precursor containing phosphorus. In this case, phosphorus may refer to PO₃²⁻, PO₄³⁻ or any combination thereof (e.g., the term “phosphorus” may in some embodiments refer to a compound or ion including phosphorus atoms).

The impregnation may be performed at a temperature of 20° C. to 40° C., and the drying may be performed at a temperature of 150° C. to 200° C.

When a solid-phase reaction is used in the above-described process of providing the ionizable phosphorus compound to the preliminary Ni-based active material precursor, it is difficult to introduce lithium phosphate into the porous core portion, compared to the above-described wet process.

In the mixture of the ionizable phosphorus compound and the solvent, the concentration of the phosphorus compound may be in a range of 0.02 M to 0.25 M. When the concentration of the ionizable phosphorus compound is within the above range, phosphorus may be well-adsorbed and coated on the surface of the Ni-based active material precursor and therein along the pores without substantial impurities, thereby obtaining a Ni-based active material having excellent lifespan characteristics.

The ionizable phosphorus-containing compound may be, for example, H₃PO₄, NH₃PO₄, NH₄HPO₄, NH₄H₂PO₄, or any combination thereof. The content of the ionizable phosphorus-containing compound may be stoichiometrically adjusted as suitable to finally obtain the Ni-based active material precursor and the Ni-based active material. As used herein, the term “preliminary Ni-based active material precursor” refers to a resultant obtained by washing a product produced using metal raw materials for forming a Ni-based active material precursor (e.g., as described herein in connection with first to third acts of growing a precursor seed). As used herein, the term “phosphorus-containing Ni-based active material precursor” refer to a resultant obtained by providing or supplying the mixture of the ionizable phosphorus compound and the solvent to the preliminary Ni-based active material precursor, as described above. The term “Ni-based active material precursor” may be used to refer to one or both of the above, and may be further understood from context.

The solvent may be or include water, an alcohol (such as ethanol, methanol, and/or isopropanol), or any combination thereof.

In the preparation of the phosphorus-containing Ni-based active material precursor, an ionizable phosphorus compound may be used as a phosphorus source. When a phosphorus compound that is difficult to ionize, such as aluminum phosphate and tungsten phosphate, is used, it may be difficult to obtain a Ni-based active material precursor having a desired or suitable structure.

The Ni-based active material precursor and the Ni-based active material obtained therefrom have multi-center spherical (e.g., substantially spherical) shapes, in which primary particles located at the outer periphery and constituting a secondary particle are radially arranged, and the core portions thereof have pores. Thus, phosphorus (P) is coated on grain boundaries of the primary particles through (e.g., delivered by way of) multiple pores formed from (e.g., in) the Ni-based active material precursor.

In the Ni-based active material precursor according to an embodiment, the content of phosphorus may be selected to hardly affect (e.g., substantially not affect) the porosity of the Ni-based active material precursor. For example, the content of phosphorus may be about 0.01 wt % to about 2 wt %, about 0.01 wt % to about 1.5 wt %, about 0.01 wt % to about 1 wt %, about 0.01 wt % to about 0.5 wt %, about 0.01 wt % to about 0.3 wt %, about 0.01 wt % to about 0.2 wt %, or about 0.01 wt % to 0.1 wt % based on the total weight of the Ni-based active material precursor. In this regard, the term “the total weight of the Ni-based active material precursor” refers to a total weight of the Ni-based active precursor material including phosphorus (e.g., the phosphorus-containing Ni-based active material precursor).

When the content of phosphorus is within the above range, a lithium secondary battery using the Ni-based active material obtained from the Ni-based active material precursor may have improved lifespan characteristics, enhanced high-rate characteristics, and/or reduced gas generation. The content of phosphorus in the Ni-based active material precursor may be confirmed or analyzed by inductively coupled plasma (ICP) analysis.

In the Ni-based active material precursor for a lithium secondary battery according to an embodiment, lithium phosphate may be present in the form of a coating film on the surface of the secondary particle. The thickness of the coating film may be 1 μm or less, for example, 500 nm or less, about 5 nm to about 300 nm, about 8 nm to about 200 nm, or for example, about 10 nm to about 50 nm. When the thickness of the coating film is within the ranges above, gas generation may be efficiently inhibited or decreased after repeated charging and discharging, lithium may be easily diffused in the interface between a positive active material and an electrolyte, and lithium may be easily diffused into the active material.

Referring to FIGS. 1A and 1B, a Ni-based active material precursor 100 has a structure including a porous core portion 10, and a shell portion 20 in which primary particles 30 having plate shapes are radially arranged. When the ionizable phosphorus compound is provided to the Ni-based active material precursor (e.g., the preliminary Ni-based active material precursor), the ionizable phosphorus compound is easily provided (e.g., deposited) at inner or outer portions thereof (e.g., of the particle) due to a plurality of paths for impregnation and/or adsorption of the ionizable phosphorus compound by the porous core portion 10. As such, phosphorus (P) 30a may be well-coated on the primary particles in the Ni-based active material precursor 100 because of the particle structure having multiple paths for impregnation and/or adsorption of the ionizable phosphorus compound, allowing easy penetration into the porous core portion via pores of the shell portion. FIG. 1B shows that phosphorus 30a is present in the porous core portion, between the plurality of primary particles of the shell portion, e.g., grain boundaries, and on the surface (e.g., outermost surface of the shell) of the secondary particle of the Ni-based active material precursor of FIG. 1A.

A according to an embodiment is a product obtained from the Ni-based active material precursor of FIG. 1B, and has substantially the same structure as the Ni-based active material precursor of FIG. 1B, except that lithium phosphate (Li₃PO₄) is present instead of phosphorus (e.g., the phosphorus (P) in the Ni-based active material is in the form of lithium phosphate). The lithium phosphate may have, for example, an amorphous phase.

A Ni-based active material for a lithium secondary battery according to an embodiment of the present disclosure includes a secondary particle including a plurality of particulate structures, wherein each of the particulate structures includes a porous core portion and a shell portion including primary particles radially arranged on the porous core portion, and lithium phosphate is present in the porous core portion, between the plurality of primary particles of the shell portion, and/or on the surface of the secondary particle.

In the Ni-based active material precursor (e.g., the phosphorus-containing Ni-based active material precursor) according to an embodiment, a ratio of a phosphorus peak intensity in the inner portion to that in the outer portion (obtained as described next) may be 1:2 to 1:4. In the Ni-based active material precursor, the phosphorus peak intensities in the porous core portion and the outer portion, and the ratio thereof, may be identified by time-of-flight secondary ion mass spectrometry (TOF-SIMS) analysis using intensity differences of PO₃ peaks in each region.

In the Ni-based active material precursor according to another embodiment, the ratio of phosphorus peak intensity in the inner portion to that in the outer portion may be, for example, in the range of 1:2.1 to 1:3.8, 1:2.3 to 1:3.7, 1:2.4 to 1:3.6, or 1:2.5 to 1:3.5. Here, the inner portion includes the porous core portion and spaces between the plurality of primary particles of the shell portion, and the outer portion refers to the surface of the secondary particle.

In the Ni-based active material according to an embodiment, the ratio of phosphorus (P) peak intensity of the inner portion (porous core portion and shell portion) to that of the outer portion (shell portion and surface of secondary particle) may be in the range of 1:2 to 1:4, 1:2.1 to 1:3.8, 1:2.3 to 1:3.7, or 1:2.5 to 1:3.5, as the above-described Ni-based active material precursor.

A Ni-based active material precursor for a lithium secondary battery according to an embodiment includes a secondary particle including a plurality of particulate structures, wherein each of the particulate structures includes a porous core portion and a shell portion including primary particles radially arranged on the porous core portion, and in 50% or more of the primary particles constituting the surface (e.g., the shell or outermost shell) of the secondary particle, the major axes of the primary particles are arranged in the normal direction of (e.g., arranged along a direction substantially normal or perpendicular to) the surface of the secondary particle.

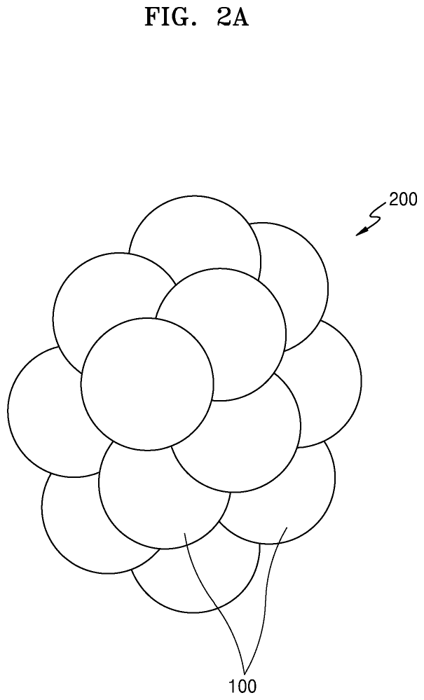

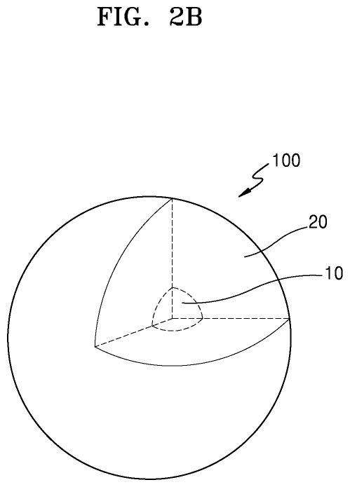

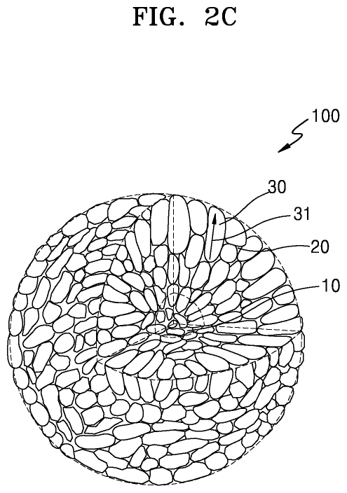

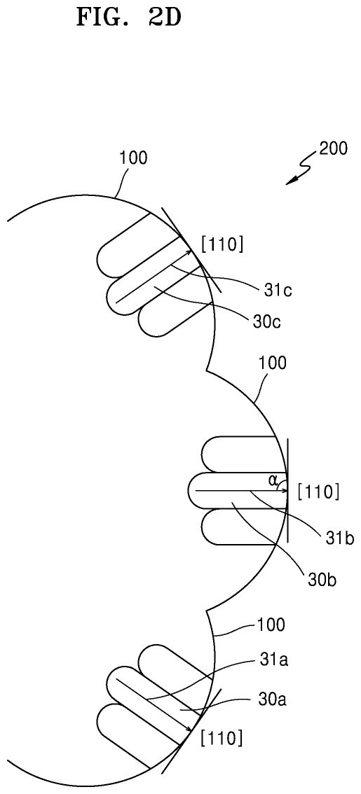

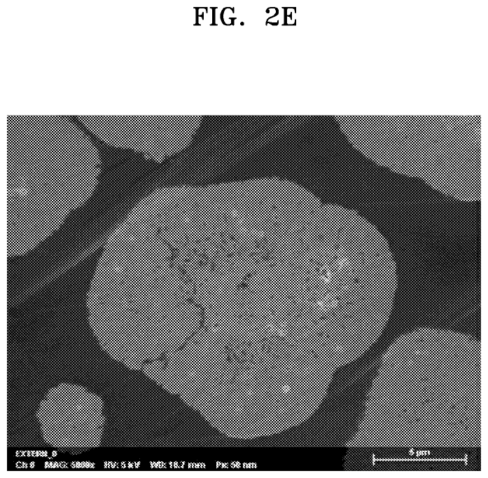

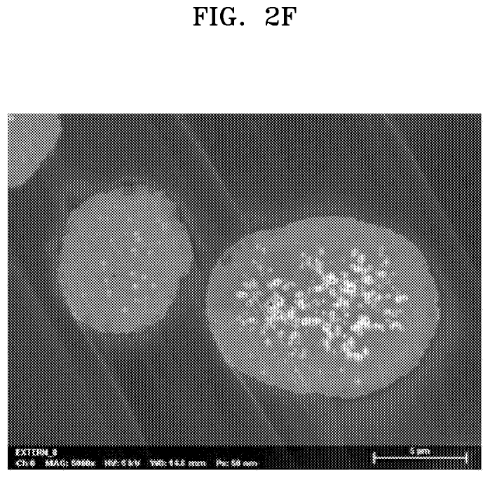

Referring to FIG. 2A, a Ni-based active material precursor for a lithium secondary battery includes a secondary particle 200 including a plurality of particulate structures, each particulate structure corresponding to the Ni-based active material precursor 100. The terms “particulate structure” and “Ni-based active material precursor” may be interchangeably used to refer to element 100 in the following description of the drawings.

Referring to FIG. 2B, each particulate structure 100, which includes a porous core portion 10 and a shell portion 20 including primary particles 30 radially arranged on the porous core portion 10. Referring to FIGS. 2C and 2D, in 50% or more of the primary particles 30 (30a, 30b, and 30c) constituting the surface of the secondary particle 200 including the plurality of particulate structures 100, the major axes 31 (31a, 31b, and 31c) of the primary particles are aligned in a substantially normal direction of the surface of the secondary particle 200. For example, in 50% or more of the primary particles 30 (30a, 30b, and 30c) constituting the surface of the secondary particle 200 including the plurality of particulate structures 100, the major axes 31 (31a, 31b, and 31c) of the primary particles are disposed at an angle (α) of about 90° with the surface of the secondary particle 200.

Referring to FIGS. 2B, 2C, and 2D, because the secondary particle 200 is an assembly of the plurality of particulate structures 100, the diffusion distance of lithium ions during charging and discharging may be reduced, as compared to a related art secondary particle including one particulate structure (e.g., particles that are singly separated spheres instead of being further assembled). The core portion 10 of the particulate structure 100 is porous, and the primary particles 30 are radially arranged on the core portion 10 to form the shell portion, thereby effectively buffering the volume change of the primary particles 30 during charging and discharging. Therefore, cracking of the secondary particles 200 due to the volume change of the secondary particle 200 during charging and discharging may be prevented or reduced. The (110) plane of the primary particle 30 is a crystal plane where (e.g., at which) lithium ions are injected into and discharged from the nickel-based active material obtained from the nickel-based active material precursor having a layered crystal structure, and according to Miller notation, the direction is perpendicular or normal to the (110) plane. When the major axes 31 (31a, 31b, and 31c) of the primary particles constituting the surface of the secondary particle 200 are aligned in the normal direction of the surface of the secondary particle 200 (e.g., substantially along or near the direction), the diffusion of lithium ions through the interface between the electrolyte and the nickel-based active material obtained from the nickel-based active material precursor may be easy (e.g., facilitated), and the diffusion of lithium ions into the nickel-based active material obtained from the nickel-based active material precursor may also be easy. Therefore, the use (e.g., utilization efficiency) of lithium ions in the nickel-based active material obtained from the nickel-based active material precursor including such a secondary particle 200 further increases.

Referring to FIGS. 2B and 2C, the “shell portion 20” refers to a region corresponding to the outermost 30% to 50%, for example, 40% of the length (distance or diameter) from the center of the particulate structure 100 to the outermost surface thereof, or for example to a region within 2 μm from the outermost surface of the particulate structure 100. The “core portion 10” refers to a region corresponding to the innermost 50% to 70%, for example, 60% of the length (distance or diameter) from the center of the particulate structure 100 to the outermost surface thereof, or for example to a region excluding the above-described region within 2 μm from the surface of the particulate structure 100. The center of the particulate structure 100 is, for example, a geometrical center of the particulate structure 100. Although a particulate structure 100 having a complete particle shape is shown in FIGS. 2B and 2C, in some embodiments, one or more particulate structures 100 may have partial particle shapes (e.g., partial sphere shapes) because the particulate structures 100 partially overlap one another in the secondary particle 200 of FIG. 2 obtained by assembling the plurality of particulate structures 100.

Referring to FIGS. 2B and 2C, in the example of the secondary particle 200, the content of the primary particles 30 (30a, 30b, and 30c) whose major axes 31 (31a, 31b, and 31c) are aligned in the normal direction of the surface of the secondary particle 200 may be about 50% to about 95%, about 50% to about 90%, about 55% to about 85%, about 60% to about 80%, about 65% to about 80%, or about 70% to about 80% with respect to the total content of the primary particles 30 (30a, 30b, and 30c) constituting the surface of the secondary particle 200. In the nickel-based active material precursor including the secondary particle 200 having the above content range of the primary particles 30, the use of lithium ions is easier. Further, referring to FIGS. 2B, 2C, and 2D, in the example of the secondary particle 200, the content of the primary particles 30 (30a, 30b, and 30c) whose major axes 31 (31a, 31b, and 31c) are aligned in the normal direction of the surface of the secondary particle 200 may be about 50% to about 95%, about 50% to about 90%, about 55% to about 85%, about 60% to about 80%, about 65% to about 80%, or about 70% to about 80% with respect to the total content of the primary particles 30 (30a, 30b, and 30c) constituting the shell portion 20 of the secondary particle 200.

Referring to FIGS. 2B and 2C, one example primary particle 30 (30a, 30b, or 30c) is a non-spherical particle having a minor axis and a major axis. The minor axis is an axis connecting the points at which the distance between both ends of the primary particle 30 (30a, 30b, or 30c) is the smallest (e.g., an axis along the smallest dimension of the primary particle), and the major axis is an axis connecting the points at which the distance between both ends of the primary particle 30, 30a, 30b, or 30c is the largest (e.g., an axis along the largest dimension of the primary particle). The ratio of minor axis to major axis of the primary particle 30 (30a, 30b, or 30c) may be, for example, 1:2 to 1:20, 1:3 to 1:20, or 1:5 to 1:15. When the ratio of the minor axis to the major axis of the primary particle 30 (30a, 30b, or 30c) is within the above ranges, the use of lithium ions in the nickel-based active material obtained from the nickel-based active material precursor is easier.

Referring to FIGS. 2B and 2C, the primary particle 30 (30a, 30b, or 30c) includes a plate particle as a non-spherical particle. The plate particle is a particle having two surfaces at opposite sides (e.g., two opposing surfaces). A length of the surface of the plate particle is greater than a thickness of the plate particle, which is a distance between the two opposite surfaces. The length of the surface of the plate particle is a larger of two lengths (dimensions) defining the surface. The two lengths defining the surface of the plate particle may be substantially the same as or different from each other, and are each greater than the thickness of the plate particle. The thickness of the plate particle is a length of the minor axis, and the length of the surface of the plate particle is a length of the major axis. The shape of the surface of the plate particle may be a polyhedron (such as a trihedron, a tetrahedron, a pentahedron, and/or a hexahedron), a circle, or an ellipse, but is not limited thereto. Any shape may be used as long as it is suitably used in the shape of the plate particle in the art. The plate particles may be, for example, nanodisks, rectangular nanosheets, pentagonal nanosheets, or hexagonal nanosheets. The shape of the plate particles may depend on the detailed conditions under which the secondary particles are produced. For example, the two surfaces of the plate particle may not be parallel to each other, the angle(s) between the surface and side surface of the plate particle may be variously changed, the edges of the surface and side surface of the plate particle may be rounded, and/or each of the surface(s) and/or side surface(s) of the plate particle may be planar or curved. The ratio of thickness to surface length of the plate particle may be, for example, 1:2 to 1:20, 1:3 to 1:20, or 1:5 to 1:15. The average thickness of one example plate particle may be about 100 nm to about 250 nm or about 100 nm to about 200 nm, and the average surface length thereof may be about 250 nm to about 1100 nm or about 300 nm to about 100 nm. The average surface length of the plate particles may be 2 to 10 times the average thickness thereof. When the plate particle has the thickness, average surface length, and the ratio thereof within the above ranges, it is easier for the plate particles to be arranged radially on the porous core portion, and as a result, the use of lithium ions is easier. Further, in the secondary particle 200, the major axes corresponding to the surface length direction of the plate particles, that is, the major axes 31 (31a, 31b, and 31c) of the primary particles are aligned in (e.g., along or with) the normal direction of the surface of the secondary particle 200. When the major axes of the plate particles are arranged in this direction, the (110) crystal plane of the plate particle, which is the crystal plane associated with lithium diffusion as occurs during the injection and discharge of lithium ions into the active material, is greatly exposed at the surface of the secondary particle 100, and thus lithium ions in the nickel-based active material precursor including plate particles as the primary particles 100 are more easily utilized.

Further, referring to FIGS. 2B and 2C, in 50% or more of the primary particles 30 (30a, 30b, and 30c) constituting the surface of the secondary particle 200, the major axis of each of the primary particles 30 (30a, 30b, and 30c) may be arranged in a normal direction of the (110) plane of the primary particles 30 (30a, 30b, and 30c) constituting the surface of the secondary particle 200. For example, in 60% to 80% of the primary particles 30 (30a, 30b, and 30c) constituting the surface of the secondary particle 200, the major axis of each of the primary particles 30 (30a, 30b, and 30c) are disposed in (e.g., aligned with) a normal direction of the (110) plane of the primary particles 30 (30a, 30b, and 30c) constituting the surface of the secondary particle 200.

Referring to FIGS. 2A and 2C, the secondary particle 200 has multiple centers, and includes the plurality of particulate structures 100 arranged in an isotropic array. The secondary particle 200 includes the plurality of particulate structures 100, and each of the particulate structures 100 includes a porous core portion 10 corresponding to the center, so that the secondary particle 200 has a plurality of centers. Therefore, in the nickel-based active material obtained from the nickel-based precursor, the travel path of lithium ions from the plurality of centers in the secondary particle 200 to the surface of the secondary particle 200 is reduced. As a result, the use of lithium ions in the nickel-based active material obtained from the nickel-based precursor is easier. Further, in the nickel-based active material obtained from the nickel-based precursor, the plurality of particulate structures 100 included in the secondary particle 200 have an isotropic arrangement in which the particles are arranged without a certain directionality, and thus it is possible to uniformly use lithium ions irrespective of the specific directions in which the secondary particles 200 are arranged. The secondary particle 200 may be, for example, a spherical particle or a non-spherical particle depending on an assembled shape of the plurality of particulate structures 100.

Referring to FIGS. 2A to 2D, in the nickel-based active material precursor, the size of the particulate structure 100 may be, for example, about 2 μm to about 7 μm, about 3 μm to about 6 μm, about 3 μm to about 5 μm, or about 3 μm to about 4 μm. When the particulate structure 100 has a size within the above range, the plurality of particulate structures 100 may be easily assembled to form an isotropic arrangement, and the use of lithium ions in the nickel-based active material obtained from the nickel-based active material precursor may be easier.

As used herein, the term “particle size” refers to an average particle diameter in the case of spherical particles, and refers to an average major axis length in the case of non-spherical particles. The particle size may be measured using a particle size analyzer (PSA).

As used herein, the term “pore size” refers to an average pore diameter or an opening width in the case of spherical or circular pores. The term “pore size” refers to an average major axis length in the case of non-spherical or non-circular pores such as elliptical pores.

Referring to FIG. 2A, in the nickel-based active material precursor, the size of the secondary particle 200 may be, for example, about 5 μm to about 25 μm or about 8 μm to about 20 μm. When the secondary particle 200 has a size within the above range, the use of lithium ions in the nickel-based active material obtained from the nickel-based active material precursor is easier.

Referring to FIGS. 2B and 2C, the pore size of the porous core portion 10 included in the particulate structure 100 may be about 150 nm to about 1 μm, about 150 nm to about 550 nm, or about 200 nm to about 800 nm. Further, the pore size of the shell portion 20 included in the particulate structure 100 may be less than 150 nm, less than 100 nm, or about 20 nm to about 90 nm. The porosity of the porous core portion 10 included in the particulate structure 100 may be about 5% to about 15% or about 5% to about 10%. Further, the porosity of the shell portion 20 included in the particulate structure 100 may be about 1% to about 5% or about 1% to about 3%. When the particulate structure 100 has a pore size and porosity within the above ranges, the capacity characteristics of the nickel-based active material obtained from the nickel-based active material precursor may be excellent. In an example of the particulate structure 100, the porosity of the shell portion 20 may be controlled to be lower than the porosity of the porous core portion 10. For example, the pore size and porosity of the porous core portion 10 may be larger than the pore size and porosity of the shell portion 20 and may be controlled irregularly, as compared to the pore size and porosity of the shell portion 20. When the porosity of the porous core portion 10 and the porosity of the shell portion 20 in the particulate structure 100 satisfy the above ranges and relationships, the density of the shell portion 20 may be increased as compared with the density of the porous core portion 10, and thus side reaction(s) of the particulate structure 100 with the electrolyte may be effectively suppressed or decreased.

In an example of the particulate structure 100, the porous core portion 10 may have closed pores, and the shell portion 20 may have closed pores and/or open pores. The closed pores may exclude electrolyte, whereas the open pores may allow the electrolyte to be contained in the pores of the particulate structure 100. Further, the porous core portion of the particulate structure 100 may have irregular pores. The core portion 10 having irregular pores, like the shell portion 20, may include plate particles, and the plate particles of the core portion 10, unlike the plate particles of the shell portion 20, may be arranged without regularity.

As used herein, the term “irregular pores” refer to pores that are not regular in pore size and pore shape and do not have uniformity. The core portion including irregular pores, unlike the shell portion, may include amorphous particles, and the amorphous particles are arranged without regularity, unlike the shell portion.

The Ni-based active material precursor may be a compound represented by Formula 1:

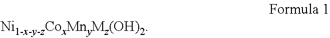

In the Formula 1, M may be an element selected from boron (B), magnesium (Mg), calcium (Ca), strontium (Sr), barium (Ba), titanium (Ti), vanadium (V), chromium (Cr), iron (Fe), copper (Cu), and zirconium (Zr), and
0.3≤(1−x−y−z)<1, 0<x<1, 0≤y<1, and 0≤z<1 are satisfied.

As described above, in the nickel-based active material precursor of Formula 1, the content of nickel is higher than the content of cobalt, and the content of nickel is higher than the content of manganese. In Formula 1, 0<x≤⅓ may be satisfied, and 0≤y≤0.5, 0≤z≤0.05, and ⅓≤(1−x−y−z)≤0.98 may be satisfied.

According to an embodiment, in Formula 1, x may be about 0.1 to about 0.3, y may be about 0.05 to about 0.3, and z may be 0.

In Formula 1, the content of Ni of the Ni-based active material precursor may be about 30 mol % to about 98 mol %, about 70 mol % to about 96 mol %, or about 85 mol % to 95 mol %.

The Ni-based active material precursor may be, for example,

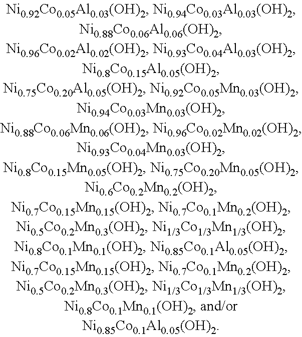

A method of preparing a Ni-based active material precursor according to another embodiment includes: a first act of supplying a feedstock at a first feed rate and stirring the feedstock to form a precursor seed; a second act of supplying the feedstock to the precursor seed formed in the first act at a second feed rate and stirring the feedstock to grow the precursor seed; and a third act of supplying the feedstock to the precursor seed grown in the second act at a third feed rate and stirring the feedstock to adjust the growth of the precursor seed, wherein the feedstock includes a complexing agent, a pH adjusting agent, and a metal raw material for forming the nickel-based active material precursor, and the second feed rate of the metal raw material for forming the nickel-based active material precursor is greater than the first feed rate, and the third feed rate is greater than the second feed rate.

A nickel-based active material precursor having the aforementioned new structure may be obtained by sequentially increasing the feed rate of the metal raw material in the order of the first act, the second act, and the third act. In the first act, the second act, and the third act, the reaction temperature may be in a range of about 40° C. to about 60° C., the stirring power may be in a range of about 0.5 kW/m³ to about 6.0 kW/m³, the pH may be in a range of about 10 to about 12, and the content of the complexing agent in the reaction mixture may be in a range of about 0.2 M to about 0.8 M, for example, about 0.4 M to about 0.6 M. In the above ranges, a nickel-based active material precursor that more closely matches the aforementioned structure may be obtained.

In the first act, the precursor seed may be formed and grown by adjusting the pH while supplying the metal raw material and the complexing agent to a reactor including an aqueous solution containing the complexing agent and the pH adjusting agent and having an adjusted pH at a set or predetermined feed rate. In the first act, the growth rate of precursor particles may be about 0.32 μm/hr±about 0.05 μm/hr. In the first act, the stirring power of the reaction mixture may be about 4 kW/m³ to about 6 kW/m³, for example 5.0 kW/m³, and the pH may be about 11 to about 12. For example, in the first act, the feed rate of the metal raw material may be about 1.0 L/hr to about 10.0 L/hr, for example, 5.1 L/hr, and the feed rate of the complexing agent may be about 0.3 times to about 0.6 times, for example, 0.45 times the molar feed rate of the metal raw material. The temperature of the reaction mixture may be about 40° C. to about 60° C., for example, 50° C., and the pH of the reaction mixture is about 11.20 to about 11.70, for example about 11.3 to about 11.5.

In the second act, the precursor seed formed in the first act is grown by changing the reaction conditions. The growth rate of the precursor seed in the second act may be equal to the growth rate of the precursor seed in the first act or may be increased by 20% or more. The feed rate of the metal raw material in the second act may be 1.1 times or more, for example, about 1.1 times to about 1.5 times as compared with the feed rate of the metal raw material in the first act, and the concentration of the complexing agent in the reaction mixture may be increased by 0.05 M or more, for example, about 0.05 M to about 0.15 M based on the concentration of the complexing agent in the first act. In the second act, the stirring power of the reaction mixture may be equal to or more than 1 kW/m² and less than 4 kW/m², for example, 3 kW/m², and the pH thereof may be about 10.5 to about 11. An average particle diameter D50 of the precursor particles obtained in the second act may be about 9 μm to about 12 μm, for example, about 10 μm.

In the third act, the growth rate of the precursor seed may be adjusted to suitably obtain a nickel-based active material precursor for a lithium secondary battery. When the average particle diameter D50 of the precursor particles in the second act reaches about 9 μm to about 12 μm, for example, about 10 μm, the third act proceeds (e.g., may be initiated). The growth rate of the precursor particles in the third act may be increased by twice or more, for example, three times or more, as compared with the growth rate of the precursor particles in the second act. For this purpose, a part of the reaction product contained in the reactor after the second act may be removed to dilute the concentration of the reaction product in the reactor. The product removed from the reactor may be used in another reactor. The feed rate of the metal raw material in the third act may be 1.1 times or more, for example, about 1.1 times to about 1.5 times as compared with the feed rate of the metal raw material in the second act, and the concentration of the complexing agent in the reaction mixture may be increased by 0.05 M or more, for example, about 0.05 M to about 0.15 M based on the concentration of the complexing agent in the second act. In the third act, a precipitate rapidly grows to obtain a nickel-based active material precursor. The stirring power of the reaction mixture in the third act may be 0.5 kW/m² or more and less than 1 kW/m², for example, 0.8 kW/m², and the pH thereof may be about 10 to about 10.5.

In the method of preparing the precursor, the feed rate of the metal raw material may be sequentially increased in the order of the first act, the second act, and the third act. For example, the feed rate of the metal raw material in the second act may be increased by about 10% to about 50% based on the feed rate of the metal raw material in the first act, and the feed rate of the metal raw material in the third act may be increased by about 10% to about 50% based on the feed rate of the metal raw material in the second act. As such, the feed rate of the metal raw material may be gradually increased to thereby suitably obtain a nickel-based active material precursor that more closely matches the aforementioned structure.

In the method of preparing the precursor, the stirring speed of the reaction mixture in the reactor may be sequentially decreased in the order of the first act, the second act, and the third act. As such, the stirring speed of the reaction mixture may be gradually decreased, thereby obtaining a nickel-based active material precursor that more closely matches the aforementioned structure.

In the method of preparing the precursor, the stirring power (e.g., stirring speed) of the reaction mixture in the reactor may be sequentially decreased in the order of the first act, the second act, and the third act. The stirring power in the first act may be about 4 kW/m² to about 6 kW/m², the stirring power in the second act may be about 1 kW/m² to about 4 kW/m², and the stirring power in the third act may be about 0.5 kW/m² to about 1 kW/m². As such, the stirring power of the reaction mixture may be gradually decreased, thereby obtaining a nickel-based active material precursor that more closely matches the aforementioned structure.

In the method of preparing the precursor, the pH of the reaction mixture in the reactor may be sequentially decreased in the order of the first act, the second act, and the third act. For example, the pH of the reaction mixture in the first act, the second act, and the third act may be in (e.g., span) a range of about 10.10 to about 11.50 when the reaction temperature is 50° C. For example, the pH of the reaction mixture in the third act may be lower than the pH of the reaction mixture in the first act at a reaction temperature of 50° C. by about 1.1 to about 1.6, or about 1.2 to about 1.5. For example, the pH of the reaction mixture in the second act may be lower than the pH of the reaction mixture in the first act by about 0.55 to about 0.85 at a reaction temperature of 50° C., and the pH of the reaction mixture in the third act may be lower than the pH of the reaction mixture in the second act by about 0.35 to about 0.55 at a reaction temperature of 50° C. As such, the pH of the reaction mixture may be gradually decreased, thereby obtaining a nickel-based active material precursor that more closely matches the aforementioned structure.

In the method of preparing the precursor, the concentration of the complexing agent included in the reaction mixture in the second act may be increased as compared with the concentration of the complexing agent included in the reaction mixture in the first act, and the concentration of the complexing agent included in the reaction mixture in the third act may be increased as compared with the concentration of the complexing agent included in the reaction temperature in the second act.

The feed rate of the metal raw material for growing the nickel-based active material precursor particles to control the growth rate of the precursor particles in the second act may be increased by about 15% to about 35%, for example, about 25%, as compared with the feed rate thereof in the first act, and the feed rate thereof in the third act may be increased by about 20% to about 35%, for example, about 33%, as compared with the feed rate thereof in the second act. Further, the feed rate of aqueous ammonia in the second act may be increased by about 10% to about 30%, for example, about 20%, based on the feed rate of aqueous ammonia in the first act to increase the density of particles.

Considering the composition of the nickel-based active material precursor, a metal precursor may be used as the metal raw material. Examples of the metal raw material may include, but are not limited to, metal carbonates, metal sulfates, metal nitrates, and metal chlorides. Any metal precursor may be used as long as it may be used in the art.

The pH adjusting agent acts to lower the solubility of metal ions in the reactor to precipitate metal ions into hydroxides. Non-limiting examples of the pH adjusting agent include sodium hydroxide (NaOH) and/or sodium carbonate (Na₂CO₃). The pH adjusting agent may be, for example, sodium hydroxide (NaOH).

The complexing agent acts to control the reaction rate in formation of a precipitate in a coprecipitation reaction. Non-limiting examples of the complexing agent include ammonium hydroxide (NH₄OH) (aqueous ammonia), citric acid, acrylic acid, tartaric acid, and/or glycolic acid. The content of the complexing agent is used at a general level. The complexing agent may be, for example, aqueous ammonia.

To obtain the Ni-based active material precursor according to an embodiment, the product obtained according to the above-described three acts is washed and an ionizable phosphorus-containing compound is added to the washed product. During washing, water and/or the like may be used. During washing, an alcohol solvent (such as ethanol, isopropanol, and/or propanol) may further be used, if desired.

The adding of the ionizable phosphorus-containing compound to the washed product is an act of impregnating the washed product in a mixture of an ionizable water-soluble phosphorus-containing compound and a solvent. The solvent may be water, an alcohol solvent, or any combination thereof.

Then, the resultant is dried to obtain a desired or suitable Ni-based active material precursor.

The Ni-based active material precursor prepared according to the above-described preparation method may be subjected to TOF-SIMS to identify the shape, structure, and composition of the Ni-based active material precursor. An Ni-based active material according to another embodiment may be obtained from the above-described Ni-based active material precursor. The Ni-based active material may be a compound represented by Formula 2:

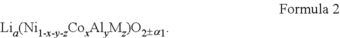

In Formula 2, M may be an element selected from boron (B), magnesium (Mg), calcium (Ca), strontium (Sr), barium (Ba), titanium (Ti), vanadium (V), chromium (Cr), iron (Fe), copper (Cu), and zirconium (Zr), and
0.95≤a≤1.1, 0.3≤(1−x−y−z)<1, 0<x<1, 0≤y<1, 0≤z<1, and 0≤1≤0.1 are satisfied.

In the compound represented by Formula 2, the content of nickel may be higher than the content of cobalt, and the content of nickel may be higher than the content of manganese. In Formula 2, 1.0≤a≤1.3 and 0<x≤⅓ may be satisfied, and 0≤y≤0.5, 0≤z≤0.05, and ⅓≤(1−x−y−z)≤0.98 may be satisfied.

In Formula 2, a may be from 1 to 1.1, x may be from 0.1 to 0.3, y may be from 0.05 to 0.3, and z may be 0.

In the Ni-based active material, the content of nickel may be about 33 mol % to about 98 mol %, for example, about 70 mol % to about 96 mol %, or for example, about 85 mol % to about 95 mol % based on the total content of the transition metals. The total content of the transition metals refers to a sum of the contents of nickel, cobalt, manganese, and M in Formula 2.

The Ni-based active material may be, for example, LiNi_{0.6}Co_{0.2}Mn_{0.2}O₂, LiNi_{0.7}Co_{0.15}Mn_{0.15}O₂, LiNi_{0.7}Co_{0.1}Mn_{0.2}O₂, LiNi_{0.5}Co_{0.2}Mn_{0.3}O₂, LiNi_{1/3}Co_{1/3}Mn_{1/3}O₂, LiNi_{0.8}Co_{0.1}Mn_{0.1}O₂, LiNi_{0.92}Co_{0.05}Al_{0.03}O₂, LiNi_{0.94}Co_{0.03}Al_{0.03}O₂, LiNi_{0.88}Co_{0.06}Al_{0.06}O₂, LiNi_{0.96}Co_{0.02}Al_{0.02}O₂, LiNi_{0.93}Co_{0.04}Al_{0.03}O₂, LiNi_{0.8}Co_{0.15}Al_{0.05}O₂O₂, LiNi_{0.75}Co_{0.20}Al_{0.05}O₂, LiNi_{0.92}Co_{0.05}Mn_{0.03}O₂, LiNi_{0.94}Co_{0.03}Mn_{0.03}O₂, LiNi_{0.88}Co_{0.06}Mn_{0.06}O₂, LiNi_{0.96}Co_{0.02}Mn_{0.02}O₂, LiNi_{0.93}Co_{0.04}Mn_{0.03}O₂, LiNi_{0.8}Co_{0.15}Mn_{0.0502}O₂, LiNi_{0.75}Co_{0.20}Mn_{0.05}O₂, LiNi_{0.6}Co_{0.2}Mn_{0.2}O₂, LiNi_{0.7}Co_{0.15}Mn_{0.15}O₂, LiNi_{0.7}Co_{0.1}Mn_{0.2}O₂, LiNi_{0.5}Co_{0.2}Mn_{0.3}O₂, LiNi_{1/3}Co_{1/3}Mn_{1/3}O₂, LiNi_{0.8}Co_{0.1}Mn_{0.1}O₂, LiNi_{0.85}Co_{0.1}Al_{0.05}O₂, or LiNi_{0.85}Co_{0.1}Al_{0.05}O₂.

The nickel-based active material may have a similar/same particle structure and/or characteristics to/as the aforementioned nickel-based active material precursor, except that lithium ions are arranged (e.g., incorporated) in the crystal structure and hydroxides are changed (e.g., converted) to oxides.

Because the secondary particle included in the nickel-based active material has multiple centers and includes a plurality of particulate structures arranged in an isotropic array, the travel distance of lithium ions and electrons from the surface of the secondary particle and the center of the secondary particle is reduced, so that intercalation and desorption (e.g., deintercalation) of lithium ions are easy, and the transmission of electrons is easy. Further, because the particulate structure included in the nickel-based active material includes the porous core portion and the primary particles radially arranged on the porous core portion, the volume of the nickel-based active material is effectively buffered during charging and discharging, and thus cycling stress of the nickel-based active material may be reduced. Accordingly, the nickel-based active material obtained from the aforementioned nickel-based active material precursor may have better (improved) capacity characteristics with respect to a material having the same composition but being a related art structure, even when the content of nickel is not increased.

As used herein, the term “multi-center” indicates that one particle has a plurality of centers. In a multi-center particle, the travel distance of lithium ions from the surface of the particle to a center of the particle may be reduced. Because the travel distance of lithium ions is reduced, a particulate structure having reduced internal resistance, increased charge-discharge efficiency, and/or long lifetime may be obtained.

The nickel-based active material includes a secondary particle including a plurality of particulate structures, and each of the particulate structure includes a porous core portion and a shell portion including primary particles radially arranged on the porous core portion. In 50% or more of the primary particles constituting the surface of the secondary particle, a major axis of each of the primary particles is aligned in (along or with) the normal direction of the surface of the secondary particle. For example, in 60% to 80% of the primary particles constituting the surface of the secondary particle, the major axis of each of the primary particles may be aligned in the normal direction of the surface of the secondary particle. In 50% or more of the primary particles constituting the surface of the secondary particle, the major axis of each of the primary particles may be aligned in the normal direction of the surface of the secondary particle. In 50% or more of the primary particles constituting the surface of the secondary particle, the direction of the major axis of each of the primary particles is (e.g., may be or coincide with the) direction (e.g., of the active material). In 60% to 80% of the primary particles constituting the surface of the secondary particle, the major axis of each of the primary particles may be aligned in the normal direction of the surface of the secondary particle. In 60% to 80% of the primary particles constituting the surface of the secondary particle, the direction of the major axis of each of the primary particles is direction. The (110) plane of the primary particle is a crystal plane where lithium ions are injected into and discharged from the nickel-based active material. When the major axis of the (one or more) primary particles at the outermost of the secondary particle is aligned in the normal direction of the surface of the secondary particle, diffusion of lithium on (at or through) the interface between the nickel-based active material and the electrolyte may be easy. The intercalation and deintercalation of lithium in the nickel-based active material may be easy, and the diffusion distance of lithium ions may be reduced. The primary particle included in the nickel-based active material includes a plate particle, the major axis of the plate particle is aligned in the normal direction of the surface of the secondary particle, and the ratio of thickness to length of the plate particle may be about 1:2 to about 1:20.

The method of preparing the nickel-based active material from the nickel-based active material precursor is not particularly limited, but may be, for example, a dry method.

The nickel-based active material may be prepared by mixing a lithium precursor and the nickel-based active material precursor at a set or predetermined molar ratio and primarily (e.g., initially) heat-treating (low-temperature heat-treating) the mixture at about 600° C. to about 800° C.

As the lithium precursor, for example, lithium hydroxide, lithium fluoride, lithium carbonate, or a mixture thereof may be used. The mixing ratio of the lithium precursor and the nickel-based active material precursor may be stoichiometrically adjusted so that the nickel-based active material of Formula 2 is suitably prepared.

The mixing of the lithium precursor and the nickel-based active material precursor may be performed by dry mixing or using a mixer. The dry mixing may be carried out by milling. The conditions of the milling are not particularly limited, but the milling may be carried out so that the precursor used as a starting material is hardly (e.g., substantially not) deformed (e.g., atomized). The size of the lithium precursor mixed with the nickel-based active material precursor may be previously controlled. The size (average particle diameter) of the lithium precursor may be in a range of about 5 μm to about 15 μm, for example, about 10 μm. A desired or suitable mixture may be obtained by milling the lithium precursor having such a size and the nickel-based active material precursor at a rotation speed of about 300 rpm to 3,000 rpm. When the temperature in the mixer increases to 30° C. or higher during the milling process, a cooling process may be performed to maintain the temperature in the mixer at or near room temperature (25° C.).

The low-temperature heat treatment may be carried out under an oxidation gas (e.g., oxidizing) atmosphere. The oxidation gas atmosphere may be obtained by using oxidation gas (such as oxygen or air). For example, the oxidation gas may include about 10 vol % to about 20 vol % of oxygen or air and about 80 vol % to about 90 vol % of an inert gas. The low-temperature heat treatment may be carried out at a temperature below densification temperature as the reaction of the lithium precursor and the nickel-based active material precursor proceeds. The densification temperature is a temperature at which sufficient crystallization may be achieved to realize a charging capacity that the active material may provide. The low-temperature heat treatment may be carried out at about 600° C. to about 800° C., for example, about 650° C. to about 800° C. The low-temperature heat treatment time varies depending on the heat treatment temperature and/or the like, but may be, for example, about 3 hours to about 10 hours.

The method of preparing the nickel-based active material may further include a secondary heat treatment (high-temperature heat treatment) performed under an oxidation gas atmosphere in which exhaust gas is suppressed from the inside of the reactor after the low-temperature heat treatment. The high-temperature heat treatment may be carried out, for example, at about 700° C. to about 900° C. The high-temperature heat treatment time varies depending on the heat treatment temperature and/or the like, but may be, for example, about 3 hours to about 10 hours.

In the Ni-based active material obtained in the above-described process, the content of lithium phosphate may be about 0.03 wt % to about 0.4 wt %, about 0.03 wt % to about 0.3 wt %, about 0.03 wt % to about 0.2 wt %, about 0.03 wt % to about 0.1 wt %, about 0.03 wt % to about 0.08 wt %, about 0.03 wt % to about 0.06 wt %, about 0.03 wt % to about 0.05 wt %, or about 0.03 wt % to about 0.04 wt % based on the total weight of the Ni-based active material.

According to another embodiment, the content of the lithium phosphate in the Ni-based active material may be about 0.04 wt % to about 0.4 wt % based on the total weight of the Ni-based active material.

The total weight of the Ni-based active material is a weight of the Ni-based active material including lithium phosphate. When the content of the lithium phosphate is within the above range, a Ni-based active material having improved electrochemical characteristics and/or excellent capacity characteristics may be obtained.

In the Ni-based active material according to an embodiment, the content of lithium phosphate present on the surface (e.g., outermost surface) of the secondary particle may be greater than the content of lithium phosphate present in the porous core portion and (e.g. between primary particles of) the shell portion. Also, according to another embodiment, in the Ni-based active material, the content of the lithium phosphate present between the plurality of primary particles of the shell portion may be greater than the content of lithium phosphate present in the porous core portion.

In the Ni-based active material according to another embodiment, the content of phosphorus present on the surface of the secondary particle may be greater than the content of phosphorus present in the porous core portion and the shell portion. Also, according to an embodiment, in the Ni-based active material, the content of phosphorus present between the plurality of primary particles of the shell portion may be greater than the content of phosphorus present in the porous core portion. In this regard, phosphorus may refer to PO₃, PO₄ or any combination thereof, for example, PO₃.

A lithium secondary battery according to another embodiment includes a positive electrode including the above-described Ni-based active material for a lithium secondary battery, a negative electrode, and an electrolyte interposed therebetween.

Methods of preparing the lithium secondary battery are not particularly limited, and any suitable method in the art may be used. For example, the lithium secondary battery may be prepared according to the following method.

The positive electrode and the negative electrode may be fabricated by applying a composition for forming a positive active material layer and a composition for forming a negative active material layer onto respective current collectors and drying the applied compositions.

The positive electrode and the negative electrode may be fabricated by forming a positive active material layer and a negative active material layer on different current collectors by applying a composition for forming a positive active material layer and a composition for forming a negative active material layer onto respective current collectors and drying the applied compositions.

The composition for forming a positive active material layer may be prepared by mixing a positive active material, a conductive material, a binder, and a solvent. As the positive active material, a positive active material according to an embodiment may be used.

The binder of the positive electrode may increase an adhesive force among (between) particles of the positive active material and an adhesive force between the positive active material and a positive current collector. Non-limiting examples of the binder include polyvinylidene fluoride (PVDF), a vinylidene fluoride/hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene butylene rubber (SBR), fluorine rubber, and/or various copolymers. These compounds may be used alone or in a combination of at least two thereof.

The conductive material is not particularly limited as long as it does not cause any unwanted chemical change in the corresponding battery, and has conductivity. Non-limiting examples of the conductive material include: graphite (such as natural graphite and/or artificial graphite); carbon-based materials (such as carbon black, acetylene black, ketjen black, channel black, furnace black, lamp black, and/or thermal black); conductive fibers (such as a carbon nanotube, a carbon fiber, and/or a metal fiber); carbon fluoride; metal powders (such as aluminum powder and/or nickel powder); conductive whiskers (such as zinc oxide and/or potassium titanate); conductive metal oxides (such as titanium oxide); and/or conductive polymers (such as polyphenylene derivatives).

The content of the conductive material may be in a range of 1 part by weight to 10 parts by weight or 1 part by weight to 5 parts by weight based on 100 parts by weight of the positive active material. When the content of the conductive material is within the above range, an electrode finally obtained may have suitable or excellent conductivity.

Non-limiting examples of the solvent may include N-methylpyrrolidone, and the content of the solvent may be in a range of 20 parts by weight to 200 parts by weight based on 100 parts by weight of the positive active material. When the amount of the solvent is within the above range, the positive active material may be easily formed.

The positive current collector is not limited as long as it has a thickness of about 3 μm to about 500 μm and has high conductivity without causing any unwanted chemical change in the corresponding battery. For example, the positive current collector may include stainless steel, aluminum, nickel, titanium, and/or fired carbon, or may include aluminum and/or stainless steel surface-treated with carbon, nickel, titanium, and/or silver. The positive current collector may have fine irregularities on the surface thereof to increase the binding force of the positive active material, and may have various forms (such as a film, a sheet, a foil, a net, a porous body, a foam, and/or non-woven fabric).

Separately, a negative active material, a binder, and a solvent may be mixed to prepare the composition for forming a negative active material layer.

A material capable of absorbing and discharging lithium ions is used as the negative active material. Non-limiting examples of the negative active material include carbon-based materials (such as graphite and/or carbon), lithium metal and alloys thereof, and/or silicon oxide-based materials. According to an embodiment of the present disclosure, silicon oxide may be used.

Non-limiting examples of the binder of the negative electrode include a polyvinylidene fluoride/hexafluoropropylene copolymer (PVDF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene terpolymer (EPDM), sulfonated EPDM, styrene butylene rubber (SBR), fluorine rubber, similar compounds thereof in which hydrogen is substituted with Li, Na, Ca, and/or the like, and/or various copolymers.

The negative active material layer may further include a conductive material. The conductive material is not particularly limited as long as it does not cause any unwanted chemical change in the corresponding battery and has conductivity. Non-limiting examples of the conductive material include: graphite (such as natural graphite and/or artificial graphite); carbon black (such as carbon black, acetylene black, ketjen black, channel black, furnace black, lamp black, and/or thermal black); conductive fibers (such as carbon fiber and/or metal fiber); conductive tubes (such as carbon nanotubes); fluorocarbons; metal powders (such as aluminum powder and/or nickel powder); conductive whiskers (such as zinc oxide and/or potassium titanate); conductive metal oxides (such as titanium oxide); and/or conductive materials (such as polyphenylene derivatives). The conductive material may be carbon black, for example, carbon black having an average particle diameter of dozens of nanometers.

The content of the conductive material may be 0.01 parts by weight to 10 parts by weight, 0.01 parts by weight to 5 parts by weight, or 0.1 parts by weight to 2 parts by weight based on 100 parts by weight of a total weight of the negative active material layer.

The composition for forming a negative active material layer may further include a thickener. As the thickener, at least one of carboxymethyl cellulose (CMC), carboxyethyl cellulose, starch, regenerated cellulose, ethyl cellulose, hydroxymethyl cellulose, hydroxyethyl cellulose, hydroxypropyl cellulose, styrene butadiene rubber (SBR), or polyvinyl alcohol may be used; for example, CMC may be used.

The content of the solvent may be in a range of 100 parts by weight to 300 parts by weight based on 100 parts by weight of the total weight of the negative active material. When the content of the solvent is within the above range, the negative active material layer may be easily formed.

In general, the negative current collector may have a thickness of 3 μm to 500 μm. The negative current collector is not particularly limited as long as it has high conductivity without causing any unwanted chemical change in the corresponding battery. For example, the negative current collector may include copper, stainless steel, aluminum, nickel, titanium, and/or fired carbon, may include copper and/or stainless steel surface-treated with carbon, nickel, titanium and/or silver, or may include an aluminum-cadmium alloy. Similarly to the positive current collector, the negative current collector may have fine irregularities on the surface thereof to increase the binding force of the positive active material, and may have various suitable forms (such as film, sheet, foil, net, porous body, foam, and/or non-woven fabric).

A separator is interposed between the positive electrode and the negative electrode fabricated according to the above-described process.

Generally, the separator has a pore diameter of about 0.01 μm to about 10 μm and a thickness of about 5 μm to about 300 μm. In one example, as the separator, a sheet or non-woven fabric made of an olefin-based polymer (such as polypropylene or polyethylene, and/or glass fiber) may be used. When a solid electrolyte (such as a polymer electrolyte) is used, the solid electrolyte may also act as a separator.

A non-aqueous electrolyte containing a lithium salt includes a non-aqueous electrolyte and a lithium salt. As the non-aqueous electrolyte, a non-aqueous electrolytic solution, an organic solid electrolyte, and/or an inorganic solid electrolyte may be used.

Non-limiting examples of the non-aqueous electrolytic solvent may include aprotic organic solvents (such as N-methyl-2-pyrrolidinone, propylene carbonate, ethylene carbonate, butylene carbonate, dimethyl carbonate, diethyl carbonate, gamma-butyrolactone, 1,2-dimethoxyethane, 2-methyl tetrahydrofuran, dimethyl sulfoxide, 1,3-dioxolane, N,N-formamide, N,N-dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ethers, methyl propionate, and/or ethyl propionate).

Non-limiting examples of the organic solid electrolyte may include polyethylene derivatives, polyethylene oxide derivatives, polypropylene oxide derivatives, phosphate ester polymers, polyester sulfide, polyvinyl alcohols, and/or polyvinylidene fluoride.

Non-limiting examples of the inorganic solid electrolyte may include a nitride, halide, and/or sulfate of Li (such as Li₃N, LiI, Li₃NI₂, Li₃N—LiI—LiOH, LiSiO₄, Li₂SiS₃, Li₄SiO₄, Li₄SiO₄—LiI—LiOH, and/or Li₃PO₄—Li₂S—SiS₂).

The lithium salt is a material easily soluble in the non-aqueous electrolyte, and non-limiting examples thereof include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (FSO₂)₂NLi, lithium chloroborate, lower aliphatic carboxylic acid lithium, and/or lithium tetraphenylborate imide.

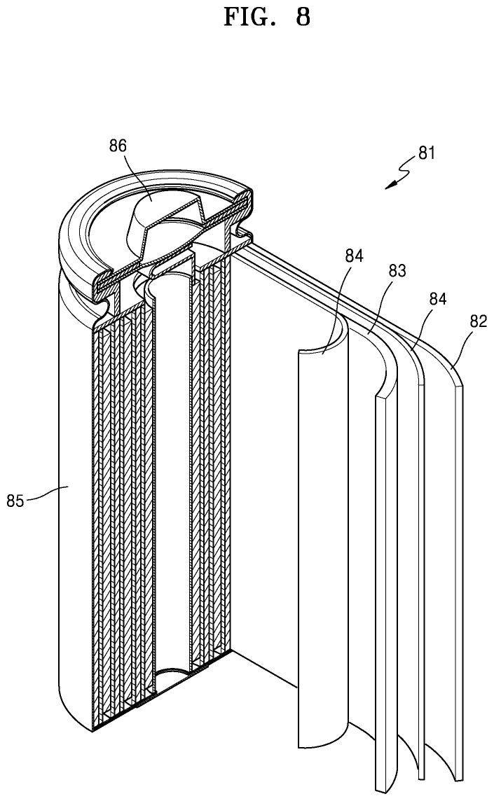

FIG. 8 is a cross-sectional view schematically illustrating a lithium secondary battery according an embodiment.

Referring to FIG. 8, a lithium secondary battery 81 includes a positive electrode 83, a negative electrode 82, and a separator 84. The positive electrode 83, the negative electrode 82, and the separator 84 may be wound or folded and accommodated in a battery case 85. The separator 84 is between the positive electrode 83 and the negative electrode 82 according to the shape of the battery, thereby forming a battery assembly. Then, an organic electrolyte is injected into the battery case 85, and the battery case 85 is sealed with a cap assembly 86 to complete the lithium secondary battery 81. The battery case 85 may have a cylindrical shape, a rectangular shape, or a thin-film shape. For example, the lithium secondary battery 81 may be a large-sized thin-film battery. The lithium secondary battery may be a lithium ion battery. The battery assembly may be accommodated in a pouch, impregnated with an organic electrolyte, and sealed, thereby completing a lithium ion polymer battery. In addition, a plurality of battery assemblies may be laminated to form a battery pack, and this battery pack may be used in all devices that require high capacity and high powder. For example, the battery pack may be used in notebook computers, smart phones, electric vehicles, and/or the like.

In addition, due to excellent storage stability, lifespan characteristics, and/or high-rate characteristics at high temperature, the lithium secondary battery may be used in electric vehicles (EVs). For example, the lithium secondary battery may be used in hybrid vehicles (such as plug-in hybrid electric vehicles (PHEVs)).

Hereinafter, the present disclosure will be described in more detail with reference to examples and comparative examples. However, these examples are for illustrating the present disclosure, and the scope of the present disclosure is not limited thereto.

### Preparation of Ni-Based Active Material Precursor

### Preparation Example 1: Preparation of Ni-Based Active Material Precursor (Ni:Co:Mn=6:2:2 (Molar Ratio))

A Ni-based active material precursor (Ni_{0.6}Co_{0.2}Mn_{0.2}(OH)₂) was synthesized by a coprecipitation method. In the following preparation process, as metal raw materials for forming a Ni-based active material precursor, nickel sulfate (NiSO₄·6H₂O), cobalt sulfate (CoSO₄·7H₂O), and manganese sulfate (MnSO₄·H₂O) were dissolved in distilled water (as a solvent) in a molar ratio of Ni:Co:Mn=6:2:2 to prepare a mixed solution. Also, aqueous ammonia (NH₄OH) for forming a complex and sodium hydroxide (NaOH) as a precipitant were prepared.

(1) First Act: Feed Rate of 5.10 L/Hr, Stirring Power of 5.0 kW/m³, 0.5 M NH₃, and pH of 11.30 to 11.50

Aqueous ammonia having a concentration of 0.5 mol/L (M) was added to a reactor equipped with a stirrer. 2 mol/L (M) of metal raw materials (mixed solution of nickel sulfate, cobalt sulfate, and manganese sulfate) were supplied at a feed rate of 5.10 L/hr, and 0.5 mol/L (M) of aqueous ammonia was supplied at a feed rate of 0.77 L/hr while maintaining a stirring power of 5.0 kW/m³ and a reaction temperature of 50° C. Then, sodium hydroxide (NaOH) was supplied to maintain the pH. The pH of the reaction mixture in the reactor was maintained at 11.30 to 11.50. The first act was performed while stirring at this pH range for 6 hours.

(2) Second Act: Feed Rate of 6.38 L/Hr, Stirring Power of 3.0 kW/m³, 0.6 M NH₃, and pH of 10.65 to 10.75

After the first act reaction was completed, 2 mol/L (M) of the metal raw materials were supplied at a feed rate of 6.38 L/hr, and 0.6 mol/L (M) of aqueous ammonia was supplied at a feed rate of 1.01 L/hr while reducing the stirring power to 3.0 KW/m³ and maintaining the reaction temperature at 50° C. Then, sodium hydroxide (NaOH) was supplied to maintain the pH. The pH of the reaction mixture in the reactor was maintained at 10.65 to 10.75. The second act was performed while stirring until an average particle diameter D50 of particles contained in the reactor reached about 10 μm. Then, a part of the product obtained in the second act reaction was removed from the reactor to reduce the concentration of the product.

(3) Third Act: Feed Rate of 8.50 L/Hr, Stirring Power of 0.8 kW/m³, 0.7 M NH₃, and pH of 10.10 to 10.20

After the second act reaction was completed and the average particle diameter D50 of the particles contained in the reactor reached about 10 μm, 2 mol/L (M) of the metal raw materials were supplied at a feed rate of 8.50 L/hr and 0.7 mol/L (M) of aqueous ammonia was supplied at a feed rate of 1.18 L/hr while reducing the stirring power to 0.8 KW/m³ and maintaining the reaction temperature at 50° C., and NaOH was added to maintain the pH. The pH of the reaction mixture in the reactor was maintained at 10.10 to 10.20. The third reaction was performed while stirring at this pH range for 6 hours. Subsequently, a slurry solution contained in the reactor was filtered and washed with high-purity distilled water. A preliminary Ni-based active material precursor that is a resultant obtained by washing as described above was impregnated in (with) a mixture of phosphoric acid (H₃PO₄) and water at 25° C. for 2 hours and dried at 150° C. for 12 hours to obtain a Ni-based active material precursor adsorbed with phosphorus. In the mixture of phosphoric acid and water, the content of phosphoric acid is 0.2 parts by weight based on 100 parts by weight of the mixture.

The precursor adsorbed with the phosphorus was dried in a hot-air oven for 24 hours to obtain a Ni-based active material precursor (Ni_{0.6}Co_{0.2}Mn_{0.2}(OH)₂) adsorbed with phosphorus.

Phosphorus was present in the porous core portion, between the plurality of primary particles of the shell portion, and on the surface of the secondary particle in the phosphorus-containing Ni-based active material precursor. In the finally obtained Ni-based active material precursor (Ni_{0.6}Co_{0.2}Mn_{0.2}(OH)₂), the total content of phosphorus (P) was 0.05 wt % based on the total weight of the Ni-based active material precursor. In this regard, phosphorus may refer to PO₃, PO₄ or any combination thereof.

### Preparation Example 2: Preparation of Ni-Based Active Material Precursor

A Ni-based active material precursor was prepared in substantially the same manner as in Preparation Example 1, except that the content of phosphoric acid was adjusted in the mixture of phosphoric acid (H₃PO₄) and water such that the total content of phosphorus was 1 wt % in the finally obtained Ni-based active material precursor (Ni_{0.6}Co_{0.2}Mn_{0.2}(OH)₂). The total content of phosphorus was 1 wt % in the finally obtained Ni-based active material precursor (Ni_{0.6}Co_{0.2}Mn_{0.2}(OH)₂) based on the total weight of the Ni-based active material precursor.

### Preparation Example 3: Preparation of Ni-Based Active Material Precursor

A Ni-based active material precursor was prepared in substantially the same manner as in Preparation Example 1, except that the content of phosphoric acid was adjusted in the mixture of phosphoric acid (H₃PO₄) and water such that the total content of phosphorus was 0.5 wt % in the finally obtained Ni-based active material precursor (Ni_{0.6}Co_{0.2}Mn_{0.2}(OH)₂). The total content of phosphorus was 0.5 wt % in the finally obtained Ni-based active material precursor (Ni_{0.6}Co_{0.2}Mn_{0.2}(OH)₂) based on the total weight of the Ni-based active material precursor.

### Preparation Example 4: Preparation of Ni-Based Active Material Precursor

A Ni-based active material precursor was prepared in substantially the same manner as in Preparation Example 1, except that the content of phosphoric acid was adjusted in the mixture of phosphoric acid (H₃PO₄) and water such that the total content of phosphorus was 2 wt % in the finally obtained Ni-based active material precursor (Ni_{0.6}Co_{0.2}Mn_{0.2}(OH)₂). The total content of phosphorus was 2 wt % in the finally obtained Ni-based active material precursor (Ni_{0.6}Co_{0.2}Mn_{0.2}(OH)₂) based on the total weight of the Ni-based active material precursor.

### Preparation Example 5: Preparation of Ni-Based Active Material Precursor (Ni:Co:Mn=7:1.5:1.5 (Molar Ratio))

A Ni-based active material precursor (Ni_{0.7}Co_{0.15}Mn_{0.15} (OH)₂) was synthesized in substantially the same manner as in Preparation Example 1, except that the mixed solution was prepared such that a molar ratio of the nickel sulfate (NiSO₄·6H₂O), cobalt sulfate (CoSO₄·7H₂O), and manganese sulfate (MnSO₄·H₂O), as metal raw materials, was Ni:Co:Mn=7:1.5:1.5 instead of Ni:Co:Mn=6:2:2 in Preparation Example 1.

### Preparation Example 6: Preparation of Ni-Based Active Material Precursor (Ni:Co:Mn=7:1:2 (Molar Ratio))

A Ni-based active material precursor (Ni_{0.7}Co_{0.1}Mn_{0.2}(OH)₂) was synthesized in substantially the same manner as in Preparation Example 1, except that the mixed solution was prepared such that a molar ratio of the nickel sulfate (NiSO₄·6H₂O), cobalt sulfate (CoSO₄·7H₂O), and manganese sulfate (MnSO₄·H₂O), as metal raw materials, was Ni:Co:Mn=7:1:2 instead of Ni:Co:Mn=6:2:2 in Preparation Example 1.

### Comparative Preparation Example 1: Preparation of Ni-Based Active Material Precursor (Ni:Co:Mn=6:2:2 (Molar Ratio))

First and second acts were performed in substantially the same manner as in Preparation Example 1.

Third Act parameters: feed rate of 8.50 L/hr, stirring power of 0.8 kW/m³, 0.7 M NH₃, and pH of 10.10 to 10.20.

After the second act reaction was completed and the average particle diameter D50 of the particles contained in the reactor reached about 10 μm, 2 mol/L (M) of the metal raw materials were supplied at a feed rate of 8.50 L/hr, and 0.7 mol/L (M) of aqueous ammonia was supplied at a feed rate of 1.18 L/hr while reducing stirring power to 0.8 KW/m³ and maintaining reaction temperature at 50° C., and NaOH was added to maintain the pH. The pH of the reaction mixture in the reactor was maintained at 10.10 to 10.20. The third act reaction was performed while stirring at this pH range for 6 hours.

After the third act reaction was completed, the slurry solution was filtered and washed with high-purity distilled water. Subsequently, the washed resultant was dried in a hot-air oven for 24 hours to obtain a Ni-based active material precursor (Ni_{0.6}Co_{0.2}Mn_{0.2}(OH)₂).

### Comparative Preparation Example 2

The Ni-based active material precursor (Ni_{0.6}Co_{0.2}Mn_{0.2}(OH)₂) obtained in Comparative Preparation Example 1 and NH₄H₂PO₄ as a phosphorus compound were mixed by milling at 250 rpm to obtain a mixture. The mixture was heat-treated in an oxygen atmosphere at about 700° C. for 6 hours to obtain a Ni-based active material precursor coated with NH₄H₂PO₄.

### Comparative Preparation Example 3

A Ni-based active material precursor was prepared in substantially the same manner as in Preparation Example 1, except that aluminum phosphate was used instead of phosphoric acid (H₃PO₄).

In the case of Comparative Preparation Example 3, because aluminum phosphate, unlike phosphoric acid, is not an ionizable phosphorus compound, it is more difficult to coat phosphorus in pores of the porous core portion of the Ni-based active material precursor and/or grain boundaries of the primary particles of the shell portion using the aluminum phosphate.

### Comparative Preparation Example 4

A Ni-based active material precursor was prepared in substantially the same manner as in Preparation Example 1, except that the content of phosphoric acid was adjusted in the mixture of phosphoric acid (H₃PO₄) and water such that the total content of phosphorus was 0.005 wt % in the finally obtained Ni-based active material precursor (Ni_{0.6}Co_{0.2}Mn_{0.2}(OH)₂). The total content of phosphorus was 0.005 wt % in the finally obtained Ni-based active material precursor (Ni_{0.6}Co_{0.2}Mn_{0.2}(OH)₂) based on the total weight of the Ni-based active material precursor

In the Ni-based active material precursor prepared in Comparative Preparation Example 4, effects obtained by including phosphorus were insignificant.

### Comparative Preparation Example 5

A Ni-based active material precursor was prepared in substantially the same manner as in Preparation Example 1, except that the content of phosphoric acid was adjusted in the mixture of phosphoric acid (H₃PO₄) and water such that the total content of phosphorus was 3 wt % in the finally obtained Ni-based active material precursor (Ni_{0.6}Co_{0.2}Mn_{0.2}(OH)₂). The total content of phosphorus was 3 wt % in the finally obtained Ni-based active material precursor (Ni_{0.6}Co_{0.2}Mn_{0.2}(OH)₂) based on the total weight of the Ni-based active material precursor.

Most of the pores of the porous inner portion disappeared in the Ni-based active material precursor prepared in Comparative Preparation Example 5. When a positive electrode including a Ni-based active material obtained therefrom is used, effects on improving lifespan characteristics of a lithium secondary battery were insignificant.

### Preparation of Ni-based Active Material

### Example 1

Lithium hydroxide (LiOH) was added to a composite metal hydroxide (Ni_{0.6}Co_{0.2}Mn_{0.2}(OH)₂), which is the phosphorus-containing Ni-based active material precursor prepared in Preparation Example 1, and mixed at a molar ratio of 1:1 by a dry method. The mixture was heat-treated at about 700° C. for 6 hours in an oxygen atmosphere to obtain a Ni-based active material (LiNi_{0.6}Co_{0.2}Mn_{0.2}O₂). The obtained Ni-based active material had an inner portion having a porous structure and an outer portion having a radial arrangement structure. The Ni-based active material was heat-treated under atmospheric conditions at about 800° C. for 6 hours to obtain a Ni-based active material (LiNi_{0.6}Co_{0.2}Mn_{0.2}O₂) including a secondary particle in which primary particle aggregates having at least two radial centers are arranged in a multi-center isotropic array.

In the Ni-based active material, the content of lithium phosphate was 0.15 wt % based on the total weight of the lithium phosphate-containing Ni-based active material. The structure of the Ni-based active material is identical to that of the Ni-based active material precursor.

As used herein, the term “radial center” refers to a center of a particulate structure including the porous core portion and the shell portion including primary particles radially arranged on the porous core portion, as shown in FIG. 1A.

### Examples 2 to 6

Additional Ni-based active materials were prepared in substantially the same manner as in Example 1, except that the Ni-based active material precursors prepared in Preparation Examples 2 to 6 were used instead of the Ni-based active material precursor of Preparation Example 1.

### Comparative Examples 1 to 5

Additional Ni-based active materials were prepared in substantially the same manner as in Example 1, except that the Ni-based active material precursors prepared in Comparative Preparation Examples 1 to 5 were used instead of the Ni-based active material precursor of Preparation Example 1.

The Ni-based active material obtained in Comparative Example 2 was prepared using the Ni-based active material precursor of Comparative Preparation Example 2, and thus lithium phosphate was formed only on the surface of the Ni-based active material. When observing the surface with a scanning electron microscope (SEM), lithium phosphate was not uniformly formed, but substantially non-uniform aggregates of lithium phosphate were formed on the surface.

Also, the Ni-based active material obtained in Comparative Example 5 was prepared using the Ni-based active material precursor of Comparative Preparation Example 5, and thus most pores of the porous inner portion of the Ni-based active material precursor disappeared. When a coin cell is prepared using the Ni-based active material according to the following method, effects on improving lifespan characteristics of the coin cell were insignificant.

### Manufacture of Coin Cell

### Manufacture Example 1

A coin cell was manufactured as follows using the Ni-based active material (LiNi_{0.6}Co_{0.2}Mn_{0.2}O₂) obtained according to Example 1 as a positive active material.

A mixture of 96 g of the Ni-based active material (LiNi_{0.6}Co_{0.2}Mn_{0.2}O₂) obtained according to Example 1, 2 g of polyvinylene fluoride, 47 g of N-methyl pyrrolidone as a solvent, and 2 g of carbon black as a conductive agent was defoamed using a mixer to prepare a uniformly dispersed slurry for forming a positive active material layer.

The slurry prepared in this way was applied onto an aluminum foil using a doctor blade to form a thin plate, and then the thin plate was dried at 135° C. for 3 hours or more and then rolled and vacuum-dried to fabricate a positive electrode.

A 2032 format coin cell was manufactured using the positive electrode and a lithium metal as a counter electrode. A separator (thickness: 16 μm) made of a porous polyethylene (PE) film was interposed between the positive electrode and the lithium metal counter electrode, and an electrolyte was injected into the separator to manufacture the 2032 format coin cell. As the electrolyte, a solution in which 1.1 M LiPF₆ was dissolved in a mixed solvent in which ethylene carbonate (EC) and ethylmethyl carbonate (EMC) were mixed at a volume ratio of 3:5 was used.

### Manufacture Example 2

A coin cell was manufactured in substantially the same manner as in Manufacture Example 1, except that the Ni-based active material of Example 2 was used instead of the Ni-based active material of Example 1.

### Manufacture Example 3

A coin cell was manufactured in substantially the same manner as in Manufacture Example 1, except that the Ni-based active material of Example 3 was used instead of the Ni-based active material of Example 1.

### Comparative Manufacture Examples 1 to 5

Coin cells were manufactured in substantially the same manner as in Manufacture Example 1, except that the Ni-based active materials prepared in Comparative Examples 1 to 5 were respectively used instead of the Ni-based active material of Example 1.

### Evaluation Example 1: Scanning Electron Microscope (SEM)

Cross-sections of the Ni-based active material precursor prepared according to Preparation Example 1 were analyzed. A Magellan 400L (FEI company) was utilized as the scanning electron microscope. Analysis results are shown in FIGS. 2E and 2F. FIG. 2E is a cross-sectional view before coating and FIG. 2F is a cross-sectional view after coating.

As shown in FIG. 2E, according to SEM analysis of the Ni-based active material precursor prepared according to Preparation Example 1, the precursor has a radial and empty (e.g., porous) center, and the shell portion has a structure in which primary particles are radially arranged. As such, the porous core portion has pores before coating and the inner pores remained even after coating without disappearing, as shown in FIG. 2F.

### Evaluation Example 2: Time-of-Flight Secondary Ion Mass Spectrometry (TOF-SIMS)

The Ni-based active materials of Example 1 and Comparative Example 2 were evaluated by TOF-SIMS. TOF-SIMS analysis was performed using an Ion TOF5 manufactured by Ion TOF. TOF-SIMS analysis was performed under the conditions of Primary ion: Bi1+, Sputter ion: Cs+.

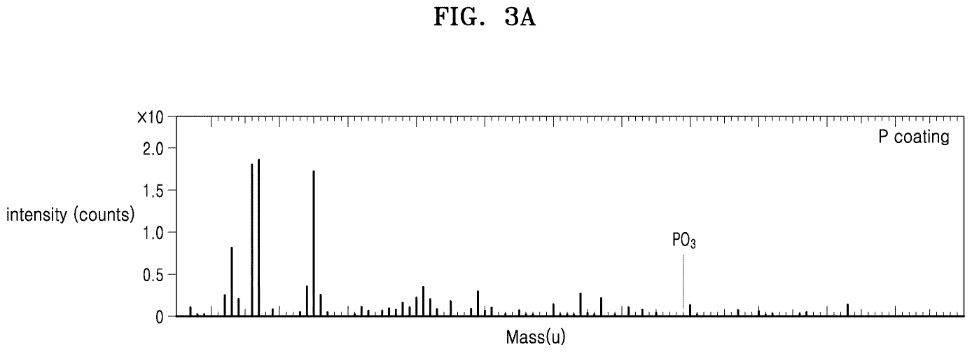

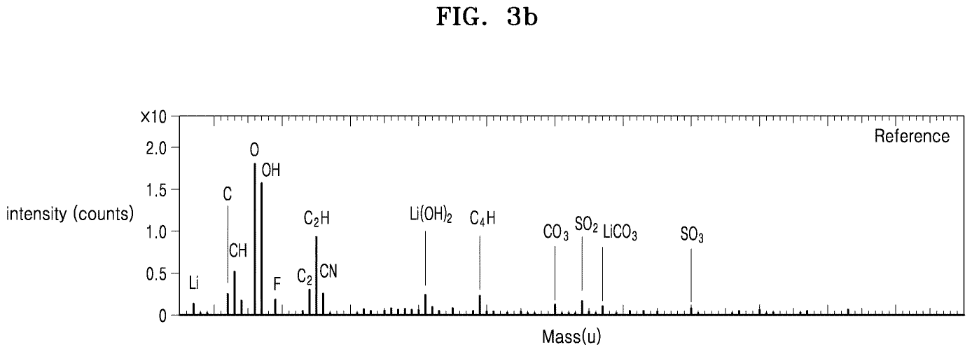

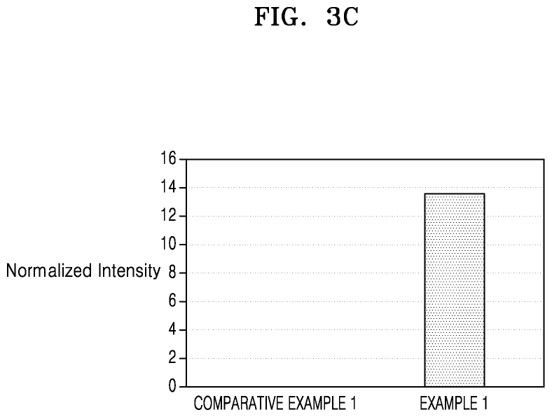

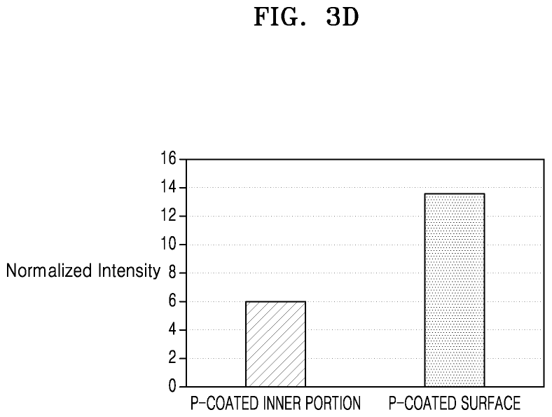

TOF-SIMS spectra are shown in FIGS. 3A to 3C. FIG. 3A shows a TOF-SIMS spectrum of the surface of the secondary particle of the Ni-based active material of Example 1. FIG. 3B shows a TOF-SIMS spectrum of the surface of the secondary particle of the Ni-based active material of Comparative Example 1. FIG. 3C is a graph comparing the PO₃ normalized intensities from the TOF-SIMS spectra of the surfaces of the secondary particles of the Ni-based active materials of Example 1 and Comparative Example 1. FIG. 3D is a graph comparing the PO₃ normalized intensities at the cross-section (inner portion) and the surface of the Ni-based active material of Example 1.

The P component was observed in the Ni-based active material of Example 1 when compared with (e.g., but not observed in) the Ni-based active material of Comparative Example 1, as shown in FIGS. 3A and 3B. As shown in FIG. 3C, the PO₃ peak related to the P component in the Ni-based active material of Example 1 was greater than that of the Ni-based active material of Comparative Example 1 by about 5 times. In addition, referring to FIGS. 3C and 3D, although P was detected in the inner portion of the Ni-based active material of Example 1, the ratio of the peak intensity related to P in the inner portion of the Ni-based active material to that in the outer portion of the Ni-based active material was in a range of 1:2 to 1:4, for example, 1:2.2, indicating that a relatively low intensity was observed in the porous inner portion compared to the shell portion and the surface. Here, the “inner portion” of the Ni-based active material includes the porous core portion and the shell portion, and the outer portion indicates the surface of the secondary particle. In FIG. 3C, the P compound observed in the Ni-based active material of Comparative Example 1 corresponds to noise.

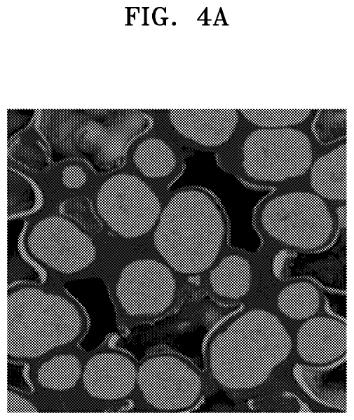

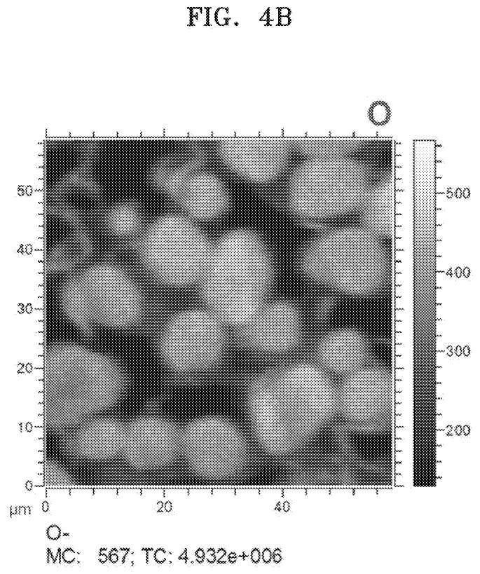

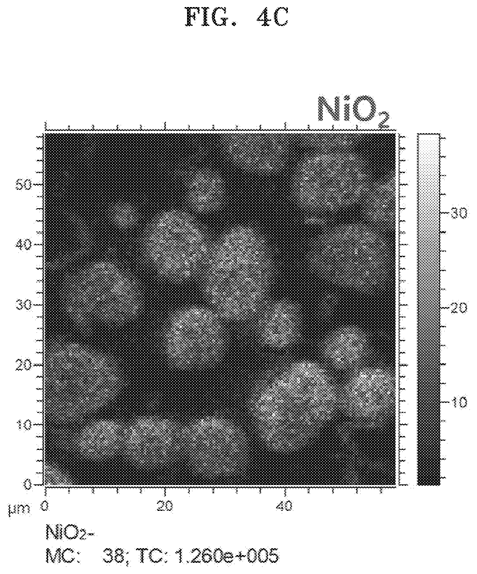

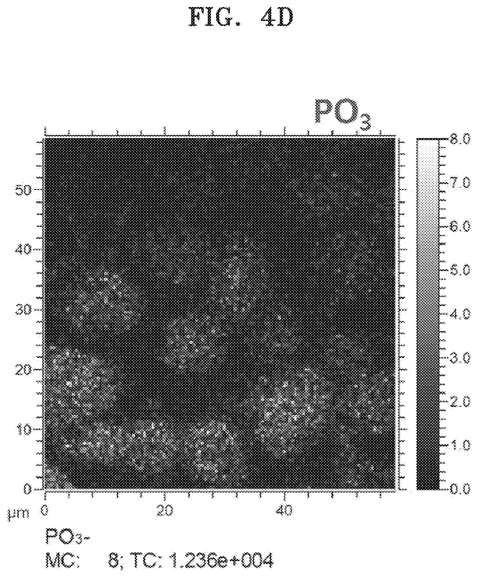

FIGS. 4A to 4D show TOF-SIMS chemical mapping results of cross-sections of the Ni-based active material of Example 1. FIG. 4A shows an SEM image of a cross-section of a P-coated Ni-based active material. FIGS. 4B to 4D show TOF-SIMS chemical mapping results of cross-sections of P-coated active materials. FIG. 4B shows mapping results of oxygen, FIG. 4C shows mapping results of NiO₂, and FIG. 4D shows mapping results of PO₃. FIG. 4E shows TOF-SIMS spectra.

Referring to the above, it may be confirmed that, as in the cross-section analysis results, when P is coated on the precursor by impregnation/adsorption and then the active material is prepared, P is detected in the inner portion as well as the surface.

Also, the Ni-based active material precursor of Preparation Example 1 was subjected to TOF-SIMS analysis.

As a result of analysis, the Ni-based active material precursor of Preparation Example 1 had the same TOF-SIMS results as the above-described Ni-based active material. Thus, the ratio of the peak intensity related to P in the inner portion of the Ni-based active material precursor to that in the outer portion of the

Ni-based active material precursor was in a range of 1:2 to 1:4, for example, 1:2.2, indicating that a relatively low intensity was observed in the porous inner portion compared to the shell portion and the surface.

### Evaluation Example 3: SEM-EDX Analysis

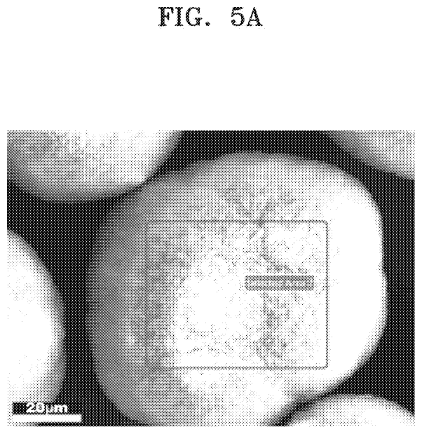

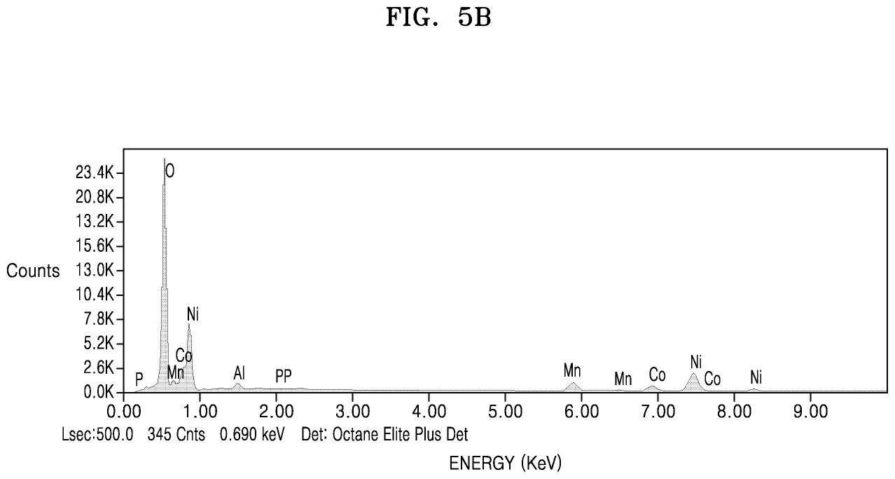

The Ni-based active material precursor of Preparation Example 1 was subjected to scanning electron microscope-energy dispersive X-ray Spectroscopy (SEM-EDX), and the results are shown in FIGS. 5A and 5B.

FIGS. 5A and 5B show SEM-EDX results of the Ni-based active material precursor of Preparation Example 1. FIG. 5B shows EDX analysis results of a rectangular area of FIG. 5A. Components of a film formed by phosphoric acid were detected in the Ni-based active material precursor of Preparation Example 1 as shown in FIG. 5B, and phosphorus was detected as a component.

### Evaluation Example 4: Initial Charge Efficiency (I.C.E.)

The coin cells manufactured according to Manufacture Example 1 and Comparative Manufacture Example 1 were charged and discharged once at 25° C. at 0.1 C as a formation protocol. Subsequently, charging-discharging was performed once at 0.1 C to confirm initial charge-discharge characteristics. During charging, the coin cells were each set such that a constant current (CC) mode starts, is converted into a constant voltage (CV) mode, and the coin cells are cut off at 4.3 V and 0.05 C. During discharging, the coin cells were set such that the coin cells are cut off at 3.0 V at the constant current (CC) mode. Initial charge efficiency (I.C.E) were measured according to Equation 1 below, and the results thereof are given in Table 1 below.

$$Initial Charge Efficiency [ \% ] = [ discharge capacity at {1}^{st} cycle / charge capacity at {1}^{st} cycle ] \times 100 \qquad Equation 1$$

TABLE 1

| | Charge capacity | Discharge capacity | |
|---|---|---|---|
| Example | (mAh/g) | (mAh/g) | I.C.E (%) |
| Manufacture | 208.41 | 200.40 | 96.2 |
| Example 1 | | | |
| Comparative | 209.38 | 201.37 | 96.2 |
| Manufacture | | | |
| Example 1 | | | |

As shown in Table 1, the coin cell manufactured according to Manufacture Example 1 had charge-discharge efficiency (initial characteristics) and initial discharge capacity similar to those of the coin cell prepared in Comparative Manufacture Example 1. However, as shown in Evaluation Examples 5 and 6 below, the coin cell of Manufacture Example 1 had improved high-rate characteristics and lifespan characteristics compared to that of Comparative Manufacture Example 1.

### Evaluation Example 5: High-Rate Characteristics

The coin cells manufactured according to Manufacture Example 1 and Comparative Manufacture Examples 1 and 2 were charged at a constant current of 0.2 C and a constant voltage of 4.3 V (0.05 C cut-off), rested for 10 minutes, and discharged at a constant current of 0.2 C, 0.33 C, 0.5 C, 1 C, 2 C, or 3 C) until the voltage reached 3.0 V. For example, rate capability of each coin cell was evaluated while periodically changing the discharge rate at 0.2 C, 0.33 C, 0.5 C, 1 C, 2 C, or 3 C as the number of charging and discharging cycles increases. However, during the first to third charging and discharging, the cell was discharged at a rate of 0.1 C. In this regard, rate capability is obtained by Equation:

$$Rate property ( \% ) = ( discharge capacity when cell is discharged at a specific constant current ) / ( discharge capacity when cell is discharged at a rate of 0.1 C ) \times 100 \qquad Equation 2$$

High-rate characteristics evaluation results are shown in Table 2:

TABLE 2

| | Capacity (mAh/g) and rate property (%) | | | | | | |
|---|---|---|---|---|---|---|---|
| | 0.1 C | 0.2 C | 0.33 C | 0.5 C | 1.0 C | 2.0 C | 3.0 C |
| Manufacture | 200.4 | 198.42 | 195.98 | 193.56 | 187.82 | 180.15 | 174.35 |
| Example 1 | 100.00% | 99.01% | 97.79% | 96.59% | 93.72% | 89.90% | 87.00% |
| Comparative | 201.37 | 199.33 | 196.87 | 194.36 | 188.58 | 180.68 | 173.75 |
| Manufacture | 100.00% | 98.99% | 97.77% | 96.52% | 93.65% | 89.73% | 86.28% |
| Example 1 | | | | | | | |

Referring to Table 2, the coin cell of Manufacture Example 1 had increased high-rate characteristics compared to the coin cell manufactured in Comparative Manufacture Example 1.

The high-rate characteristics of the coin cell of Comparative Manufacture Example 2 was evaluated in substantially the same manner as in the above-described method of evaluating the charge-discharge efficiency of Manufacture Example 1.

As a result of evaluation, the coin cell of Comparative Manufacture Example 2 had the same discharge amount as that of the coin cell of Comparative Manufacture Example 1 but a slightly increased charge-discharge efficiency due to a decreased charge amount. However, the coin cell of Comparative Manufacture Example 2 showed deteriorated lifespan characteristics at high temperature, as described in Evaluation Example 6 below.

### Evaluation Example 6: Lifespan Characteristics at High Temperature

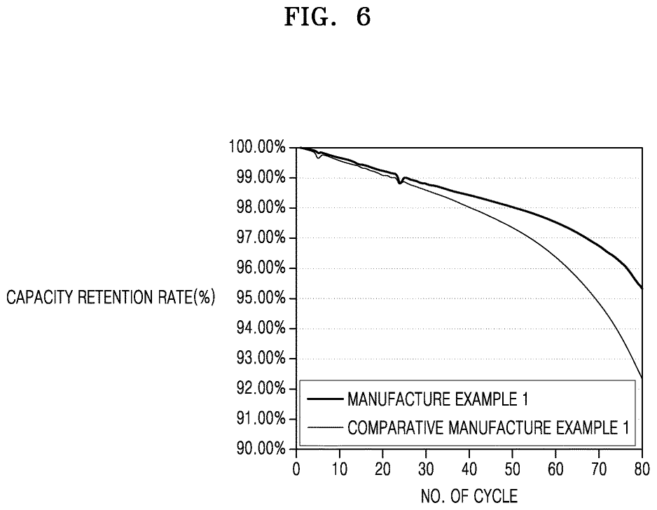

The coin cells manufactured according to Manufacture Example 1 and Comparative Manufacture Examples 1 and 2 were charged and discharged once at 0.1 C to proceed formation. Subsequently, charging-discharging was performed once at 0.2 C to confirm initial charge-discharge characteristics. Cycle characteristics were observed by repeating charging and discharging 50 times at 45° C. and 1 C. During charging, the coin cells were set such that a constant current (CC) mode starts, is converted into a constant voltage (CV) mode, and the coin cells are cut off at 4.3 V and 0.05 C. During discharging, the coin cells were set such that the coin cells are cut off at 3.0 V at the constant current (CC) mode. This cycle was repeated 80 times. Changes in discharge capacity with respect to the number of cycles are shown in FIG. 6.

Referring to FIG. 6, the coin cell of Manufacture Example 1 had improved lifespan characteristics compared to that of Comparative Manufacture Example 1.

Lifespan characteristics of the coin cell of Comparative Manufacture Example 2 at high temperature (e.g., 60° C.) were evaluated in substantially the same manner as the evaluation method of the charge-discharge efficiency of the coin cell of Manufacture Example 1.

As a result of evaluation, the coin cell of Comparative Manufacture Example 2 lifespan characteristics at high temperature less than those of the coin cell of Comparative Manufacture Example 1 by about 1%.

### Evaluation Example 7: Gas Generation

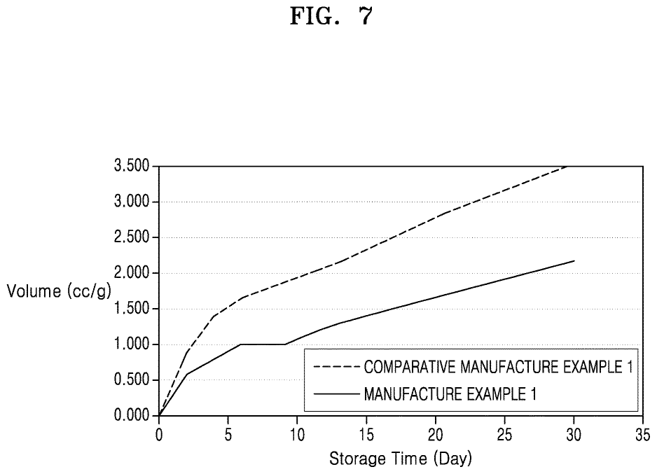

The lithium secondary batteries prepared in Manufacture Example 1 and Comparative Manufacture Example 1 were charged and discharged 50 times at a high temperature (60° C.) at a driving voltage of 3 V to 4.4 V under the conditions of 0.5 C/1 C, and the volume of gas generated in the batteries was measured. The results are shown in FIG. 7.

Referring to FIG. 7, the coin cell of Manufacture Example 1 showed far less gas generation than the coin cell of Comparative Manufacture Example 1 prepared using the Ni-based active material not including lithium phosphate as a positive active material.

By using the Ni-based active material obtained from the Ni-based active material precursor for a lithium secondary battery according to an embodiment, gas generation may effectively be inhibited during and after repeated charging and discharging of the lithium secondary battery. In addition, by using the Ni-based active material precursor, lithium may be easily diffused in the interface between a positive active material and an electrolyte, and lithium may be easily diffused into the active material. Further, it is possible to obtain a nickel-based active material that easily intercalates and deintercalates lithium, and has a short diffusion distance of lithium ions. In the lithium secondary battery manufactured using such a positive active material, the utilization of lithium is improved, and the breakage of the active material according to charging and discharging may be suppressed to increase capacity and/or lifetime.

As used herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that embodiments described herein should be considered in a descriptive sense only and not for purposes of limitation. Descriptions of features or aspects within each embodiment should typically be considered as being available for other similar features or aspects in other embodiments. While one or more embodiments have been described with reference to the figures, it will be understood by those of ordinary skill in the art that various suitable changes in form and details may be made therein without departing from the spirit and scope of the disclosure, as defined by the following claims and equivalents thereof.

What is claimed is:

1. A nickel (Ni)-based active material for a lithium secondary battery, the Ni-based active material comprising a secondary particle comprising a plurality of particulate structures,
wherein each of the plurality of particulate structures comprises:
a porous core portion; and
a shell portion comprising a plurality of primary particles radially arranged on the porous core portion,
wherein lithium phosphate is present in the porous core portion, between the plurality of primary particles of the shell portion, and on the surface of the secondary particle.

2. The Ni-based active material according to claim 1, wherein the content of lithium phosphate present on the surface of the secondary particle is greater than the content of lithium phosphate present in the porous core portion and between the plurality of primary particles.

3. The Ni-based active material according to claim 1, wherein the content of the lithium phosphate is in a range of 0.03 wt % to 0.4 wt % based on a total weight of the Ni-based active material comprising the lithium phosphate.

4. The Ni-based active material according to claim 1, wherein a ratio of a peak intensity of phosphorus (P) in the porous core portion and the shell portion to a peak of phosphorus on the surface of the secondary particle, obtained by time-of-flight secondary ion mass spectrometry (TOF-SIMS) of the Ni-based active material, is in a range of 1:2 to 1:4.

5. The Ni-based active material according to claim 1, wherein the primary particles comprise plate particles,
wherein major axes of the plate particles are oriented along a normal direction to the surface of the secondary particle, and
wherein a thickness-to-length ratio of the plate particles is in a range of 1:2 to 1:20.

6. The Ni-based active material according to claim 1, wherein the plurality of particulate structures are arranged in a multi-center isotropic array.

7. The Ni-based active material according to claim 1, wherein the porous core portion has a pore size of 150 nm to 1 μm.

8. The Ni-based active material according to claim 1, wherein the porous core portion has a porosity of 5% to 15%, and the shell portion has a porosity of 1% to 5%.

9. The Ni-based active material according to claim 1, wherein the Ni-based active material is a compound represented by Formula 2: 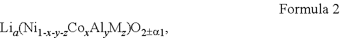
wherein, in Formula 2, M is an element selected from among boron (B), magnesium (Mg), calcium (Ca), strontium (Sr), barium (Ba), titanium (Ti), vanadium (V), chromium (Cr), iron (Fe), copper (Cu), and zirconium (Zr), and 0.95≤a≤1.1, 0.3≤(1−x−y−z)<1, 0<x<1, 0≤y<1, 0≤z<1, and 0≤α1≤0.1 are satisfied.

10. The Ni-based active material according to claim 9, wherein in Formula 2, 1.0≤a≤1.1 and 0<x≤⅓, 0≤y≤0.5, 0≤z≤0.05, and ⅓≤(1−x−y−z)≤0.98.

11. The Ni-based active material according to claim 1, wherein the Ni-based active material is a product prepared by a preparing method comprising
a step of mixing a lithium precursor and a Ni-based active material precursor and performing a primary heat treatment at 600 to 800° C. in a reactor, and
a secondary heat treatment step performed at 700 to 900° C. under an oxidation gas atmosphere in which exhaust gas is suppressed from an inside of the reactor after the primary heat treatment.

12. A lithium secondary battery comprising:
a positive electrode comprising the Ni-based active material according to claim 1;
a negative electrode; and
an electrolyte interposed therebetween.

13. A method, the method comprising:
a step of mixing a lithium precursor and a Ni-based active material precursor and performing a primary heat treatment at 600 to 800° C. in a reactor; and
a secondary heat treatment step performed at 700 to 900° C. under an oxidation gas atmosphere in which exhaust gas is suppressed from an inside of the reactor after the primary heat treatment to prepare the Ni-based active material according to claim 1.

14. The method according to claim 13, wherein the Ni-based active material precursor is prepared by a method comprising:
a first act of supplying a feedstock at a first feed rate and stirring the feedstock to form a precursor seed;
a second act of supplying the feedstock to the precursor seed formed in the first act at a second feed rate and stirring the feedstock to grow the precursor seed;
a third act of supplying the feedstock to the precursor seed grown in the second act at a third feed rate and stirring the feedstock to adjust the growth of the precursor seed; and
acts of washing a product obtained in the third act to obtain a preliminary Ni-based active material precursor, and supplying an ionizable phosphorus-containing compound to the preliminary Ni-based active material precursor to obtain a phosphorus-containing Ni-based active material precursor,
wherein the feedstock comprises a complexing agent, a pH adjusting agent, and a metal raw material for forming the Ni-based active material precursor, and
the second feed rate of the metal raw material for forming the Ni-based active material precursor is greater than the first feed rate, and the third feed rate is greater than the second feed rate.

15. The method according to claim 14, wherein the ionizable phosphorus-containing compound is H₃PO₄, (NH₄)₃PO₄, (NH₄)₂HPO₄, NH₄H₂PO₄, or any combination thereof.

16. The method according to claim 14, wherein the supplying of the ionizable phosphorus-containing compound to the preliminary Ni-based active material precursor comprises impregnating the preliminary Ni-based active material precursor with a mixture of the ionizable phosphorus-containing compound and a solvent.

17. The method according to claim 14, wherein a power utilized during stirring of the feedstock is sequentially decreased from the first act to the second act, and from the second act to the third act.
